(19) United States
(12) Patent Application Publication
(10) Pub. No.: US 2007/0172758 A1
(43) Pub. Date: Jul. 26, 2007

(54) Planographic printing plate material and its manufacturing process

(75) Inventor: Tatsuichi Maehashi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/650,832

(22) Filed: Jan. 8, 2007

(30) Foreign Application Priority Data
Jan. 20, 2006 (JP) JP2006-012254
Feb. 16, 2006 (JP) JP2006-039149

(51) Int. Cl. G03C 1/00

(52) U.S. Cl. 430/270.1

(57) ABSTRACT

Disclosed is a planographic printing plate material comprising a hydrophilic support and provided thereon, an image formation layer whose alkali solubility is changed after near-infrared laser exposure, wherein the image formation layer contains, as a infrared absorbent, a compound having absorption maximum in the wavelength regions of from 700 to 900 nm, the compound being selected from the group consisting of compounds represented by formulae IRD1, IRD2 and IRD3,

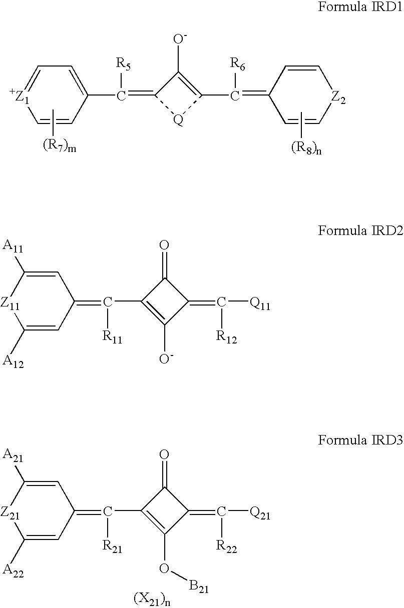

This application is based on Japanese Patent Application No. 2006-012254, filed on Jan. 20, 2006 in Japanese Patent Office, and Japanese Patent Application No. 2006-039149, filed on Feb. 16, 2006 in Japanese Patent Office, the entire content of which is hereby incorporated by reference.

### FIELD OF THE INVENTION

The present invention relates to a planographic printing plate material comprising a negative or positive image formation layer which is used for so-called a computer-to-plate system (hereinafter referred to as CTP system), and particularly to a planographic printing plate material capable of forming an image on near-infrared laser exposure having high sensitivity and excellent developability and a manufacturing process thereof.

### BACKGROUND OF THE INVENTION

As a negative working image formation layer (hereinafter also referred to as light sensitive layer) for a negative working planographic printing plate material, which is insolubilized at exposed portions by actinic ray exposure, there is known an image formation layer (as disclosed in for example, Japanese Patent O.P.I. Publication Nos. 52-7364 and 52-3216), in which polymerization or cross-linking reaction occurs at the exposed portions, whereby an image is formed. In U.S. Pat. No. 5,340,699 is disclosed an image forming material comprising a light sensitive layer containing an acid generation compound, a cross-linking agent (a resol resin), a binder (a novolak resin) and an infrared absorbent, wherein an image formation layer at exposed portions is alkali insolubilized by infrared ray exposure, whereby an image is formed.

As a positive working image formation layer to be solubilized by actinic light irradiation for a positive working planographic printing plate material, an image formation layer containing an acid generation compound and an acid decomposable compound is known. There are, for example, an image formation layer containing an orthocarboxylic acid or a carboxylic acid amide acetal group as disclosed, for example, in U.S. Pat. No. 3,779,779, a an image formation layer containing a compound having an acetal structure in the main chain as disclosed, for example, in Japanese Patent O.P.I. Publication No. 53-133429, and an image formation layer containing a compound having a silylether group as disclosed, for example, in Japanese Patent O.P.I. Publication No. 65-37549.

In recent years, printing image data are digitized and a so-called CTP system is widely used which comprises exposing a planographic printing plate material employing laser signals to which the digitized data are converted. Presently, laser technique is markedly developed, and a compact solid or semiconductor laser with high output power, which has an emission wavelength of from near infrared to infrared regions, is available from the market. Such a laser is extremely useful as a light source for manufacturing a printing plate employing digitized data from a computer.

Since a composition containing an infrared absorbent, which absorbs near-infrared rays to generate heat and a compound, which is decomposed by the generated heat to generate an acid, has sensitivity to infrared laser, a negative or positive planographic printing plate material comprising such a composition is put into practical use.

As the infrared absorbent are generally used inorganic pigments such as carbon black and iron oxide and organic pigments such as a cyanine dye, a methine dye, a naphthoquinone dye, a substituted arylbenzo(thio)pyrylium salt, a trimethine thiapyrylium salt and a pyrylium salt In printing industries, a planographic printing plate material with high sensitivity for the CTP system is desired on which an image can be formed employing an inexpensive and compact light source. It is effective as one of methods for obtaining high sensitivity to increase an infrared absorbent content of the image formation layer of a planographic printing plate material, which increases the absorbance and light to heat conversion efficiency of the image formation layer. However, an image formation layer having a high content of a conventional infrared absorbent lowers developability of the image formation layer at non-image portions, which tends to lower a printing image quality and printing durability at image portions.

### SUMMARY OF THE INVENTION

The present invention has been made in view of the above. An object of the invention is to provide a planographic printing plate material comprising a negative or positive image formation layer capable of being exposed by near-infrared laser exposure to form an image and its manufacturing process. Another object of the invention is to provide a planographic printing plate material providing high sensitivity and high printing qualities and its manufacturing process.

### DETAILED DESCRIPTION OF THE INVENTION

The above object of the invention can be attained by the followings:

1. A planographic printing plate material comprising a hydrophilic support and provided thereon, an-image formation layer whose alkali solubility is changed after near-infrared laser exposure, wherein the image formation layer contains, as an infrared absorbent, a compound having absorption maximum in the wavelength regions of from 700 to 900 nm, the compound being selected from the group consisting of compounds represented by formulae IRD1, IRD2 and IRD3,

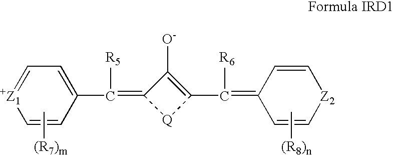

wherein Z₁ and Z₂ independently represent an oxygen atom (O), a sulfur atom (S), a selenium atom (Se) or a tellurium atom (Te); Q represents >C═O or —C(═O)—C(═O)—; R₅ and R₆ independently represent a hydrogen atom or an alkyl group; m and n independently represent an integer of from 0 to 4; and R₇ and R₈ independently represent a substituent, provided that when m is not less than 2, the nearest two R₇'s may combine with each other to form a ring, and when n is not less than 2, the nearest two R₈'s may combine with each other to form a ring,

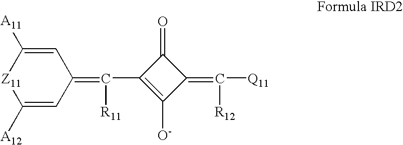

wherein R₁₁ and R₁₂ independently represent a hydrogen atom or a substituent; Z₁₁ represents O, S, N—R₁, Se or Te, in which R₁ represents an alkyl group or an aryl group; Q₁₁ represents a six-member heterocyclic group; and A₁₁ and A₁₂ independently represent a substituent, provided that A₁₁ and A₁₂ are not the same,

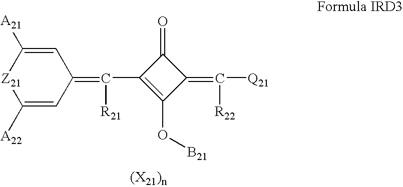

wherein R₂₁ and R₂₂ independently represent a hydrogen atom or a substituent; Z₂₁ represents O, S, N—R₂, Se or Te, in which R₂ represents an alkyl group or an aryl group; Q₂₁ represents a six-member heterocyclic group; and A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, and n is 0 or 1.

2. The planographic printing plate material of item 1 above, wherein the compound represented by formula IRD2 and the compound represented by formula IRD3 is a compound represented by formula IRD4, and a compound represented by formula IRD5, respectively,

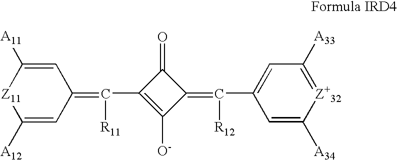

wherein R₁₁ and R₁₂ independently represent a hydrogen atom or a substituent; Z₁₁ represents O, S, N—R₁, Se or Te, in which R₁ represents an alkyl group or an aryl group; A₁₁ and A₁₂ independently represent a substituent, provided that A₁₁ and A₁₂ are not the same; Z₃₂ represents O, S, N—R₃, Se or Te, in which R₃ represents an alkyl group or an aryl group; and A₃₃ and A₃₄ independently represent a hydrogen atom or a substituent,

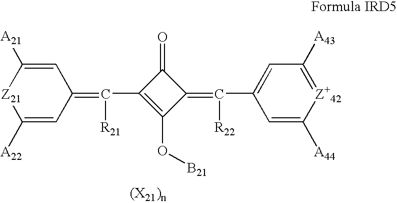

wherein R₂₁ and R₂₂ independently represent a hydrogen atom or a substituent; Z₂₁ represents O, S, N—R₂, Se or Te, in which R₂ represents an alkyl group or an aryl group; A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, n is 0 or 1; Z₄₂ represents O, S, N—R₄, Se or Te, in which R₄ represents an alkyl group or an aryl group; and A₄₃ and A₄₄ independently represent a hydrogen atom or a substituent.

3. The planographic printing plate material of item 2 above, wherein the compound represented by formula IRD4 and the compound represented by formula IRD5 is a compound represented by formula IRD6, and a compound represented by formula IRD7, respectively,

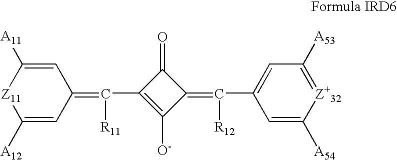

wherein R₁₁ and R₁₂ independently represent a hydrogen atom or a substituent; Z₁₁ represents O, S, N—R₁, Se or Te, in which R₁ represents an alkyl group or an aryl group; A₁₁ and A₁₂ independently represent a substituent, provided that A₁₁ and A₁₂ are not the same; Z₃₂ represents O, S, N—R₃, Se or Te, in which R₃ represents an alkyl group or an aryl group; and A₅₃ and A₅₄ independently represent a substituent, provided that A₅₃ and A₅₄ are not the same,

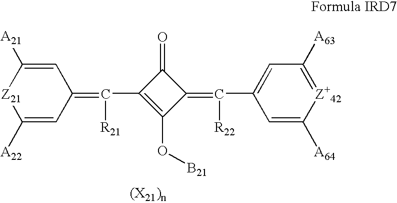

wherein R₂₁ and R₂₂ independently represent a hydrogen atom or a substituent; Z₂₁ represents O, S, N—R₂, Se or Te, in which R₂ represents an alkyl group or an aryl group; A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, and n is 0 or 1; Z₄₂ represents O, S, N—R₄, Se or Te, in which R₄ represents an alkyl group or an aryl group; and A₆₃ and A₆₄ independently represent a substituent, provided that A₆₃ and A₆₄ are not the same. 4. The planographic printing plate material of item 3 above, wherein the compound represented by formula IRD6 and the compound represented by formula IRD7 is a compound represented by formula IRD8, and a compound represented by formula IRD9, respectively,

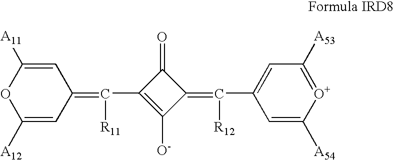

wherein R₁₁ and R₁₂ independently represent a hydrogen atom or a substituent; A₁₁ and A₁₂ independently represent a substituent; and A₅₃ and A₅₄ independently represent a substituent, provided that A₅₃ and A₅₄ are not the same,

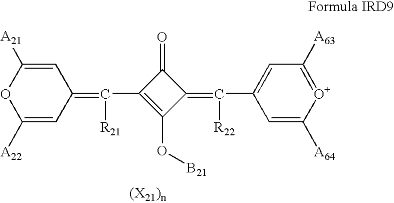

wherein R₂₁ and R₂₂ independently a hydrogen atom or a substituent; A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, n is 0or 1; and A₆₃ and A₆₄ independently represent a substituent, provided that A₆₃ and A₆₄ are not the same.

5. The planographic printing plate material of item 4 above, wherein the compound represented by formula IRD8 is a compound represented by formula IRD10,

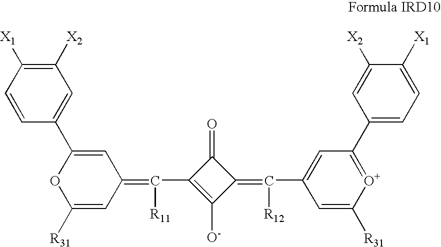

wherein R₁₁ and R₁₂ independently represent a hydrogen atom or a substituent; X₁ and X₂ independently represent a halogen atom; and R₃₁ represents an alkyl group.

6. The planographic printing plate material of any one of items 1 through 5 above, wherein the hydrophilic support is an aluminum support obtained by a process comprising the steps of electrolytically surface roughening an aluminum plate and anodizing the electrolytically surface roughened aluminum plate, and the image formation layer further contains an alkali soluble binder, a cross-linking agent and an acid generation compound.

7. The planographic printing plate material of item 6 above, wherein the alkali soluble binder is novolak resin.

8. The planographic printing plate material of item 6 above, wherein the cross-linking agent is a melamine resin.

9. The planographic printing plate material of item 6 above, wherein the acid generation compound is a triazine compound.

10. The planographic printing plate material of item 6 above, wherein the electrolytically surface roughening is carried out in a hydrochloric acid solution.

11. The planographic printing plate material of any one of items 1 through 5 above, wherein the hydrophilic support is an aluminum support obtained by a process comprising the steps of electrolytically surface roughening an aluminum plate and anodizing the electrolytically surface roughened aluminum plate, and the image formation layer further contains an alkali soluble binder, an acid decomposable compound and an acid generation compound.

12. The planographic printing plate material of item 11 above, wherein the alkali soluble binder is novolak resin.

13. The planographic printing plate material of item 11 above, wherein the acid generation compound is a triazine compound.

14. The planographic printing plate material of item 11 above, wherein the electrolytically surface roughening is carried out in a hydrochloric acid solution.

15. A process of manufacturing a planographic printing plate material, the process comprising the steps of dissolving a composition comprising a compound having absorption maximum in the wavelength regions of from 700 to 900 nm in a ketone solvent to provide a light sensitive coating liquid, and coating the light sensitive coating liquid on a hydrophilic support, wherein the compound is selected from the group consisting of compounds represented by formulae IRD1, IRD2 and IRD3 above.

The present invention is characterized in that in a planographic printing plate material comprising a hydrophilic support and provided thereon, an image formation layer whose alkali solubility is changed after near-infrared laser exposure, the image formation layer contains a compound having absorption maximum in the wavelength regions of from 700 to 900 nm in the methyl ethyl ketone solution, the compound being selected from the group consisting of the compounds represented by formulae IRD1, IRD2 and IRD3 described above.

The present invention will be explained in detail below.

### Infrared Absorbent

In the invention, a compound having absorption maximum in the wavelength regions of from 700 to 900 nm in the methyl ethyl ketone solution is used as an infrared absorbent, the compound being represented by any one of formulae IDR1 through IRD10 above.

### (Compound Represented by Formula IRD1)

In formula IRD1, Z₁ and Z₂ independently represent an oxygen atom (O), a sulfur atom (S), a selenium atom (Se) or a tellurium atom (Te); Q represents >C═O or —C(═O)—C(═O)—; R₅ and R₆ independently represent a hydrogen atom or an alkyl group; m and n independently represent an integer of from 0 to 4; and R₇ and R₈ independently represent a substituent, provided that when m is 2 or more, the nearest two R₇'s may combine with each other to form a ring, and when n is 2 or more, the nearest two R₈'s may combine with each other to form a ring.

The substituent represented by R₇ and R₈ represents an alkyl group, a cycloalkyl group, an alkenyl group, an alkynyl group, an aryl group, a heterocyclic group, a halogen atom or a cyano group. Typical examples of the alkyl group include a methyl group, an ethyl group, a propyl group, an isopropyl group, a t-butyl group, a pentyl group, a hexyl group, an octyl group, a dodecyl group, and a trifluoromethyl group; typical examples of the cycloalkyl group include a cyclopentyl group or a cyclohexyl group; typical examples of the alkenyl group include a vinyl group, 2-propenyl group, a 3-butenyl group, a 1-methyl-3-propenyl group, a 3-pentenyl group, a 1-methyl-3-butenyl group, a hexenyl group and a cyclohexenyl group; typical examples of the alkinyl group include a propargyl group; typical examples of the aryl group include a phenyl group or a naphthyl group; typical examples of the heterocyclic group include a pyridyl group, a thiazolyl group, an oxazolyl group or an imidazolyl group; and typical examples of the halogen atom include fluorine, chlorine, bromine, and iodine.

Examples of the compound represented by formula IRD1 are listed below, but the invention is not limited thereto.

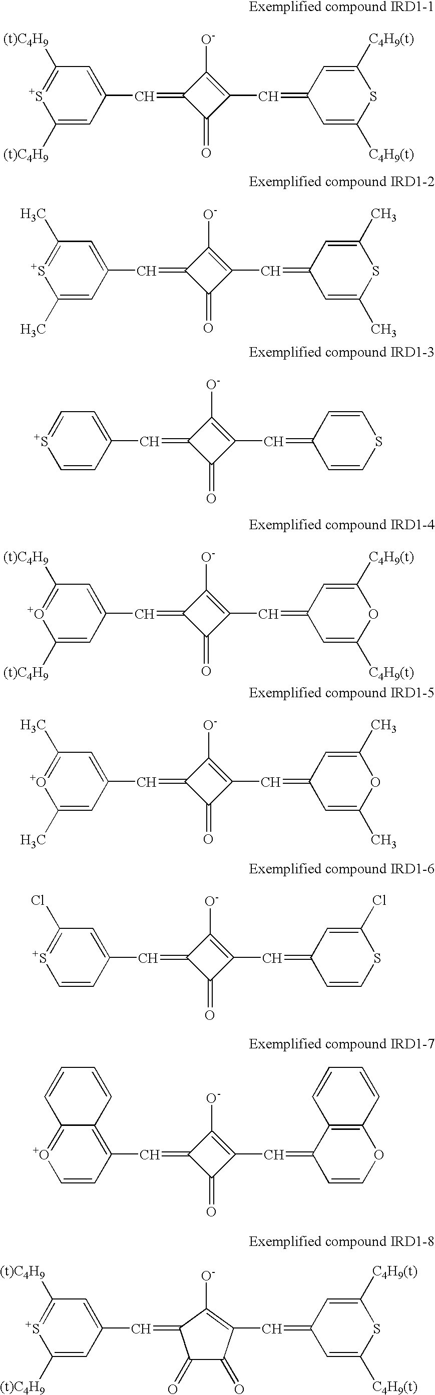

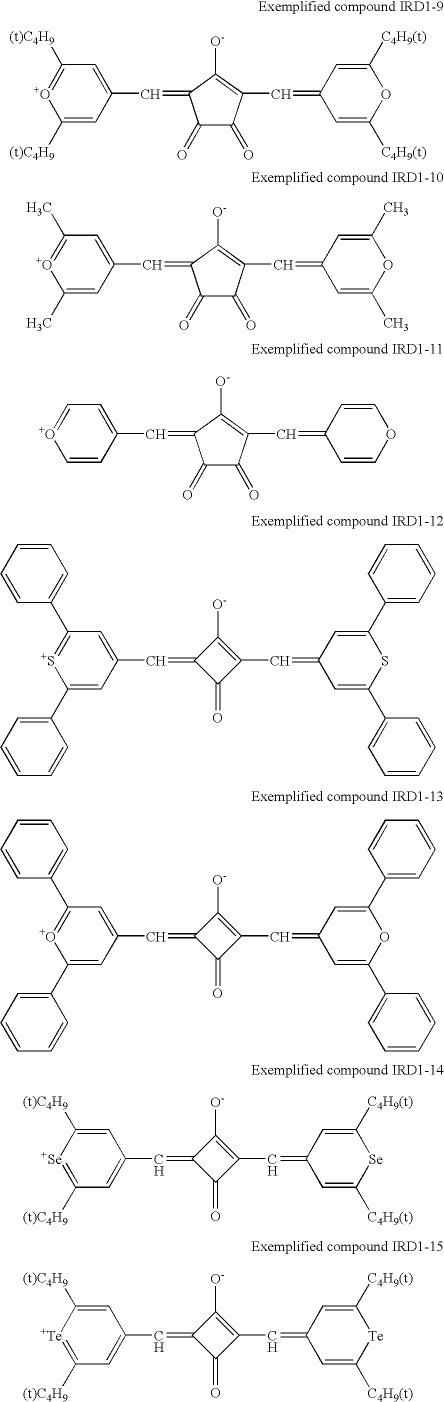

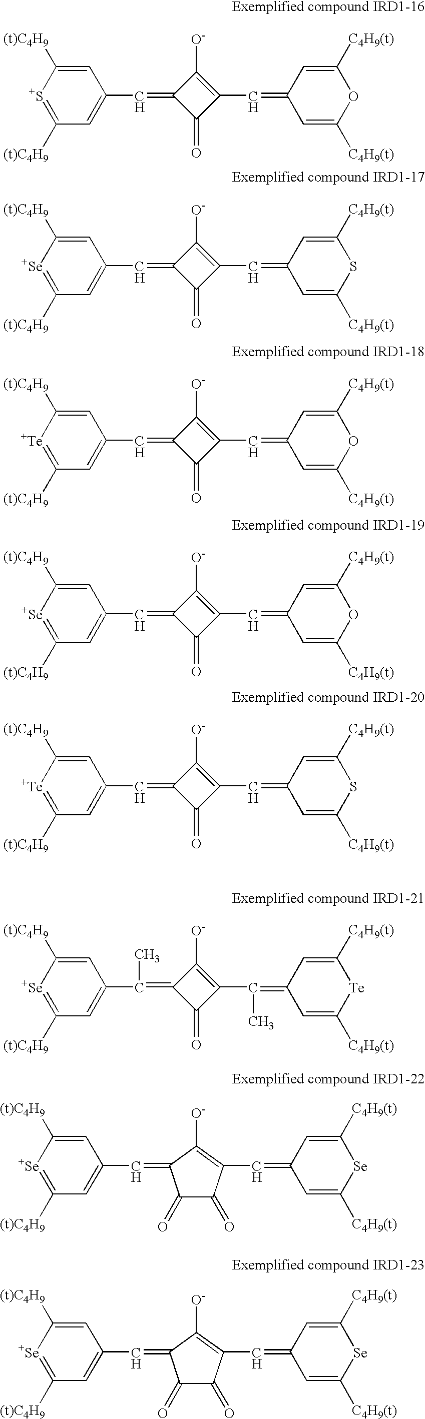

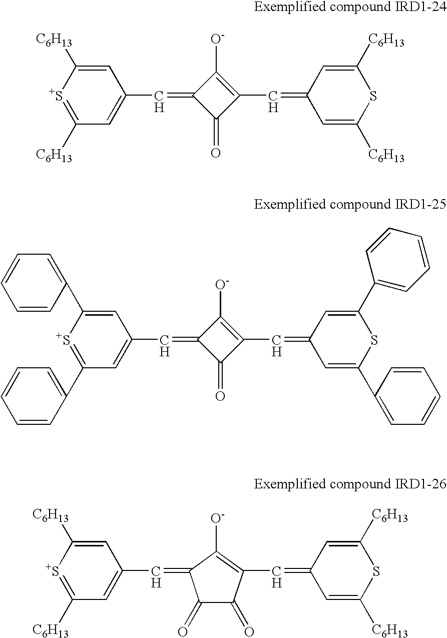

### (Compound Represented by Formula IRD2)

The compound represented by formula IRD2 is an inner salt. In formula IRD2, R₁₁ and R₁₂ independently represent a hydrogen atom or a substituent. The substituent represented by R₁₁ and R₁₂ is an alkyl group, a cycloalkyl group, an alkenyl group, an alkynyl group, an aryl group, a heterocyclic group, a halogen atom or a cyano group. R₁₁ and R₁₂ are preferably a hydrogen atom, an alkyl group or an aryl group, and more preferably a hydrogen atom or an alkyl group.

Typical examples of the alkyl group include a methyl group, an ethyl group, a propyl group, an isopropyl group, a t-butyl group, a pentyl group, a hexyl group, an octyl group, a dodecyl group, and a trifluoromethyl group; typical examples of the cycloalkyl group include a cyclopentyl group or a cyclohexyl group; typical examples of the alkenyl group include a vinyl group, 2-propenyl group, a 3-butenyl group, a 1-methyl-3-propenyl group, a 3-pentenyl group, a 1-methyl-3-butenyl group, a hexenyl group and a cyclohexenyl group; typical examples of the alkinyl group include a propargyl group; typical examples of the aryl group include a phenyl group or a naphthyl group; typical examples of the heterocyclic group include a pyridyl group, a thiazolyl group, an oxazolyl group or an imidazolyl group; and typical examples of the halogen atom include fluorine, chlorine, bromine, and iodine.

Z₁₁ represents O, S, N—R₁, Se or Te, in which R₁ represents an alkyl group or an aryl group. Z₁l is preferably O, S or N—R₁, and more preferably O or S.

Typical examples of the alkyl group of R₁ include a methyl group, an ethyl group, a propyl group, an isopropyl group, a t-butyl group, a pentyl group, a hexyl group, an octyl group, a dodecyl group, and a trifluoromethyl group; and typical examples of the aryl group of R₁ include a phenyl group and a naphthyl group.

Q₁₁ represents a six-member heterocyclic group. Examples of the six-member heterocyclic group include pyrylium, thiopyrylium, selenopyrylium, telluropyrylium, pyridinium, benzpyridinium, benzthiopyrylium and benzselenopyrylium. Q₁₁ is preferably pyrylium, thiopyrylium or selenopyrylium, and more preferably pyrylium or thiopyrylium. The six-member heterocyclic group may have a substituent. Examples of the substituent on the six-member heterocyclic group include an alkyl group, a cycloalkyl group, a halogenated alkyl group, an alkenyl group, an alkynyl group, an aryl group, a heterocyclic group, a halogen atom, a cyano group a hydroxyl group, a carboxyl group, an alkoxy group, an aryloxy group, a silyloxy group, a heterocyclic-oxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, an heterocyclicthio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, an heterocyclicazo group, an imido group, a silyl group, a hydrazino group, a ureido group, a boric acid group, a phosphate group, and a sulfate group.

A₁₁ and A₁₂ independently represent a substituent. Examples of the substituent include an alkyl group, a cycloalkyl group, an alkenyl group, an alkynyl group, an aryl group, a heterocyclic group, a halogen atom or a cyano group. These substituents may further have another substituent. A₁₁ and A₁₂ may be the same or different.

Typical examples of the alkyl group, cycloalkyl group, alkenyl group, alkynyl group, aryl group, heterocyclic group and a halogen atom are the same as those denoted in R₁₁ and R₁₂ described above.

### (Compound Represented by Formula IRD3)

In formula IRD3, R₂₁ and R₂₂ independently represent a hydrogen atom or a substituent. The substituent represented by R₂₁ and R₂₂ is an alkyl group, a cycloalkyl group, an alkenyl group, an alkynyl group, an aryl group, a heterocyclic group, a halogen atom or a cyano group. R₂₁ and R₂₂ are preferably a hydrogen atom, an alkyl group or an aryl group, and more preferably a hydrogen atom or an alkyl group.

Typical examples of the alkyl group, cycloalkyl group, alkenyl group, alkynyl group, aryl group, heterocyclic group and halogen atom are the same as those denoted in R₁₁ and R₁₂ described above.

Z₂₁ represents O, S, N—R₂, Se or Te, in which R₂ represents an alkyl group or an aryl group. Z₂₁ is preferably O, S or N—R₂, and more preferably O or S.

Typical examples of the alkyl group or aryl group of R₂ are the same as those denoted in R₁ described above.

Q₂₁ represents a six-member heterocyclic group. Examples of the six-member heterocyclic group include pyrylium, thiopyrylium, selenopyrylium, telluropyrylium, pyridinium, benzpyridinium, benzthiopyrylium and benzselenopyrylium. Q₂₁ is preferably pyrylium, thiopyrylium or selenopyrylium, and more preferably pyrylium or thiopyrylium. The six-member heterocyclic group may have a substituent. Examples of the substituent include an alkyl group, a cycloalkyl group, a halogenated alkyl group, an alkenyl group, an alkynyl group, an aryl group, a heterocyclic group, a halogen atom, a cyano group a hydroxyl group, a carboxyl group, an alkoxy group, an aryloxy group, a silyloxy group, a heterocyclic-oxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, an heterocyclicthio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, an heterocyclicazo group, an imido group, a silyl group, a hydrazino group, a ureido group, a boric acid group, a phosphate group, and a sulfate group.

A₂₁ and A₂₂ independently represent a substituent. Examples of the substituent include an alkyl group, a cycloalkyl group, an alkenyl group, an alkynyl group, an aryl group, a heterocyclic group, a halogen atom or a cyano group. These substituents may further have another substituent. A₂₁ and A₂₂ may be the same or different.

Typical examples of the alkyl group, cycloalkyl group, alkenyl group, alkynyl group, aryl group, heterocyclic group and halogen atom of A₂₁ and A₂₂ are the same as those denoted in A₁₁ and A₁₂ described above.

B₂₁ represents an alkyl group or an aryl group, and is preferably an alkyl group.

Typical examples of the alkyl group of B₂₁ include a methyl group, an ethyl group, a propyl group, an isopropyl group, a t-butyl group, a pentyl group, a hexyl group, an octyl group, a dodecyl group, and a trifluoromethyl group, and typical examples of the aryl group of B₂₁ include a phenyl group and a naphthyl group.

X₂₁ represents an ion necessary to neutralize the charge of the molecule, and n is 0 or 1. When the compound represented by formula IRD3 forms an inner salt, n is 0.

### (Compound Represented by Formula IRD4)

The compound represented by formula IRD4 is an inner salt.

In formula IRD4, R₁₁ and R₁₂ are the same as those denoted above in R₁₁ and R₁₂ of formula IRD2. Z₁₁ is the same as those denoted above in Z₁₁ of formula IRD2. A₁₁ and A₁₂ are the same as those denoted above in A₁₁ and A₁₂ of formula IRD2.

Z₃₂ represents O, S, N—R₃, Se or Te, in which R₃ represents an alkyl group or an aryl group. Z₃₂ is preferably O, S or N—R₃, and more preferably O or S.

Typical examples of the alkyl group or aryl group of R₃ are the same as those denoted in R₁ described above.

A₃₃ and A₃₄ independently represent a hydrogen atom or a substituent. Examples of the substituent include an alkyl group, a cycloalkyl group, an alkenyl group, an alkynyl group, an aryl group, a heterocyclic group, a halogen atom or a cyano group. These substituents may further have another substituent. In Formula IRD4, typical examples of the alkyl group, cycloalkyl group, alkenyl group, alkynyl group, aryl group, heterocyclic group and halogen atom of A₃₃ and A₃₄ are the same as those denoted in A₁₁ and A₁₂ described above.

### (Compound Represented by Formula IRD5)

In formula IRD5, R₂₁ and R₂₂ are the same as those denoted above in R₂₁ and R₂₂ of formula IRD3. Z₂₁ is the same as those denoted above in Z₂₁ of formula IRD3. A₂₁ and A₂₂ are the same as those denoted above in A₂₁ and A₂₂ of formula IRD3.

B₂₁ is the same as those denoted above in B₂₁ of formula IRD3. X₂₁ is the same as those denoted above in X₂₁ of formula IRD3, and n is the same as those denoted above in n of formula IRD3.

Z₄₂ represents O, S, N—R₄, Se or Te, in which R₄ represents an alkyl group or an aryl group. Z₃₁ is preferably O, S or N—R₄, and more preferably O or S.

Typical examples of the alkyl group or aryl group of R₃ are the same as those denoted in R₁ described above.

A₄₃ and A₄₄ independently represent a hydrogen atom or a substituent. Examples of the substituent include an alkyl group, a cycloalkyl group, an alkenyl group, an alkynyl group, an aryl group, a heterocyclic group, a halogen atom or a cyano group. These substituents may further have another substituent. In Formula IRD5, typical examples of the alkyl group, cycloalkyl group, alkenyl group, alkynyl group, aryl group, heterocyclic group and halogen atom of A₄₃ and A₄₄ are the same as those denoted in A₁₁ and A₁₂ described above.

### (Compound Represented by Formula IRD6)

The compound represented by formula IRD6 is an inner salt.

In formula IRD6, R₁₁ and R₁₂ are the same as those denoted above in R₁₁ and R₁₂ of formula IRD2. Z₁₁ is the same as those denoted above in Z₁₁ of formula IRD2. A₁₁ and A₁₂ are the same as those denoted above in A₁₁ and A₁₂ of formula IRD2.

Z₃₂ is the same as those denoted above in Z₃₂ of formula IRD4.

A₅₃ and A₅₄ independently represent a substituent. Examples of the substituent include an alkyl group, a cycloalkyl group, an alkenyl group, an alkynyl group, an aryl group, a heterocyclic group, a halogen atom or a cyano group. These substituents may further have another substituent. A₅₃ and A₅₄ may be the same or different. In Formula IRD5, typical examples of the alkyl group, cycloalkyl group, alkenyl group, alkynyl group, aryl group, heterocyclic group and halogen atom of A₅₃ and A₅₄ are the same as those denoted in A₁₁ and A₁₂ described above.

### (Compound Represented by Formula IRD7)

In formula IRD7, R₂₁ and R₂₂ are the same as those denoted above in R₂₁ and R₂₂ of formula IRD3. Z₂₁ is the same as those denoted above in Z₁₁ of formula IRD3. A₂₁ and A₂₂ are the same as those denoted above in A₂₁ and A₂₂ of formula IRD3.

B₂₁ is the same as those denoted above in B₂₁ of formula IRD3. X₂₁ is the same as those denoted above in X₂₁ of formula IRD3, and n is the same as those denoted above in n of formula IRD3. Z₄₂ is the same as those denoted above in Z₄₂ of formula IRD5.

A₆₃ and A₆₄ independently represent a substituent. Examples of the substituent include an alkyl group, a cycloalkyl group, an alkenyl group, an alkynyl group, an aryl group, a heterocyclic group, a halogen atom or a cyano group. These substituents may further have another substituent. A₆₃ and A₆₄ may be the same or different. In Formula IRD7, typical examples of the alkyl group, cycloalkyl group, alkenyl group, alkynyl group, aryl group, heterocyclic group and halogen atom of A₆₃ and A₆₄ are the same as those denoted in A₁₁ and A₁₂ described above.

### (Compound Represented by Formula IRD8)

In formula IRD8, R₁₁ and R₁₂ are the same as those denoted above in R₁₁ and R₁₂ of formula IRD2. A₁₁ and A₁₂ are the same as those denoted above in A₁₁ and A₁₂ of formula IRD2. A₅₃ and A₅₄ are the same as those denoted above in A₅₃ and A₅₄ of formula IRD6.

### (Compound Represented by Formula IRD9)

In formula IRD9, R₂₁ and R₂₂ are the same as those denoted above in R₂₁ and R₂₂ of formula IRD3. A₂₁ and A₂₂ are the same as those denoted above in A₂₁ and A₂₂ of formula IRD3. B₂₁ is the same as those denoted above in B₂₁ of formula IRD3.

X₂₁ is the same as those denoted above in X₂₁ of formula IRD3, and n is the same as those denoted above in n of formula IRD3. A₆₃ and A₆₄ are the same as those denoted above in A₆₃ and A₆₄ of formula IRD7.

### (Compound Represented by Formula IRD10)

The compound represented by formula IRD8 is preferably a compound represented by formula IRD10, in reducing the absorption of a 400 to 700 nm light. In formula IRD10, R₁l and R₁₂ are the same as those denoted above in R₁₁ and R₁₂ of formula IRD2. X₁ and X₂ represent a halogen atom. X₁ and X₂ are preferably chlorine or bromine, and more preferably chlorine.

R₃₁ represents an alkyl group. Examples of the alkyl group include a methyl group, an ethyl group, an n-propyl group, a t-butyl group, an octyl group, a t-amyl group, a 2-ethylhexyl group, a 2-chloroethyl group, a 3,3,3-trifluoropropyl group, a 6-cyanohexyl group, a cyclohexyl group, and a 4-trifluoromethylcyclohexyl group. R₃₁ is preferably a t-butyl group, and more preferably a 2-alkoxy-1,1-dimethylethyl group. Examples of the alkoxy group include a methoxy group, an ethoxy group, a butoxy group, an iso-butoxy group, a 3-methylbutoxy group and a 2-ethylhexyloxy group. The alkoxy group is preferably an iso-butoxy group, a 3-methylbutoxy group or a 2-ethylhexyloxy group.

Examples of compounds represented by formulae IRD1 through IRD10 are listed below, but the invention is not limited thereto.

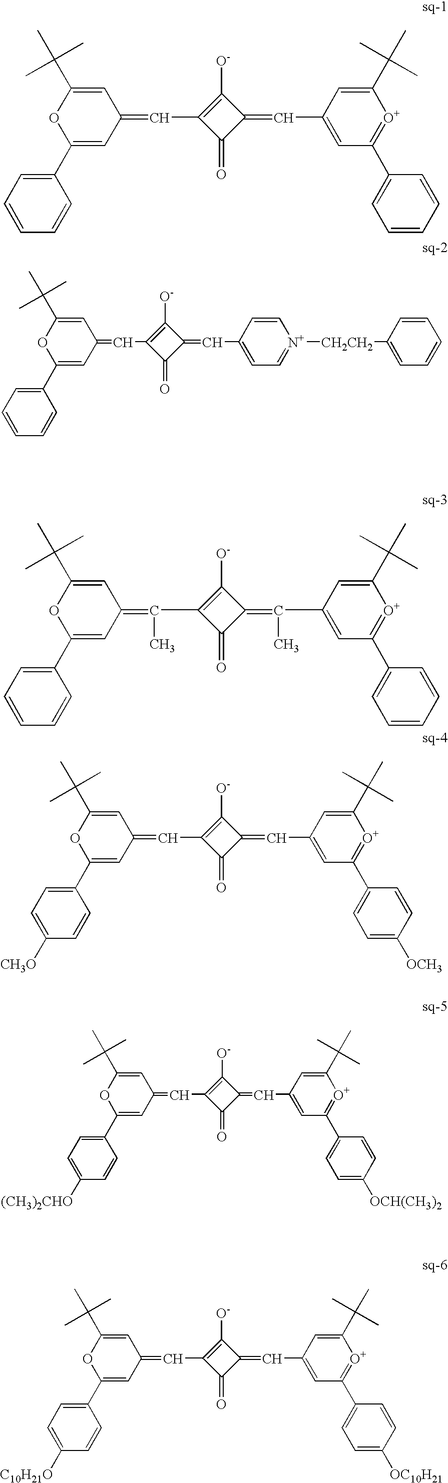

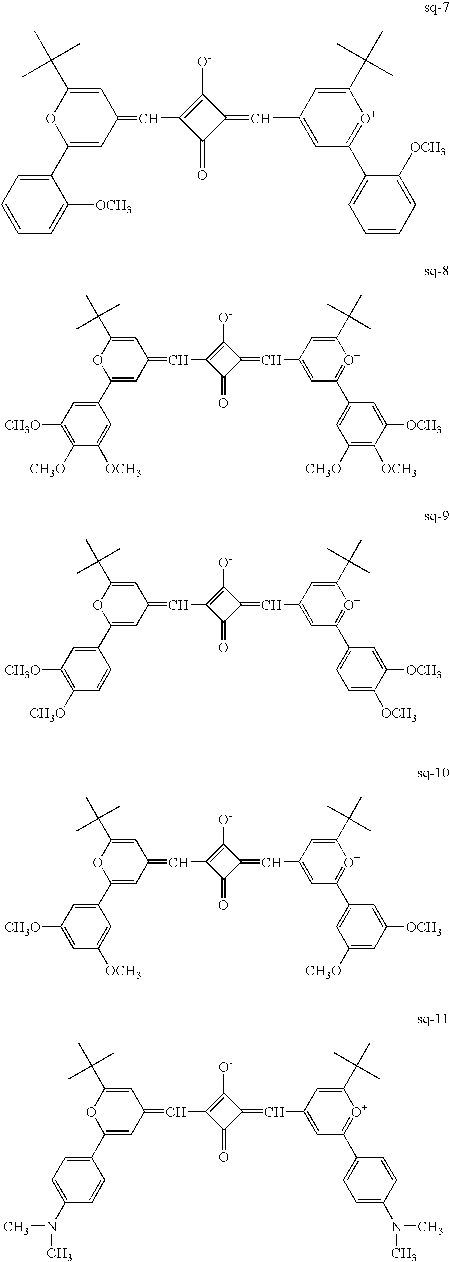

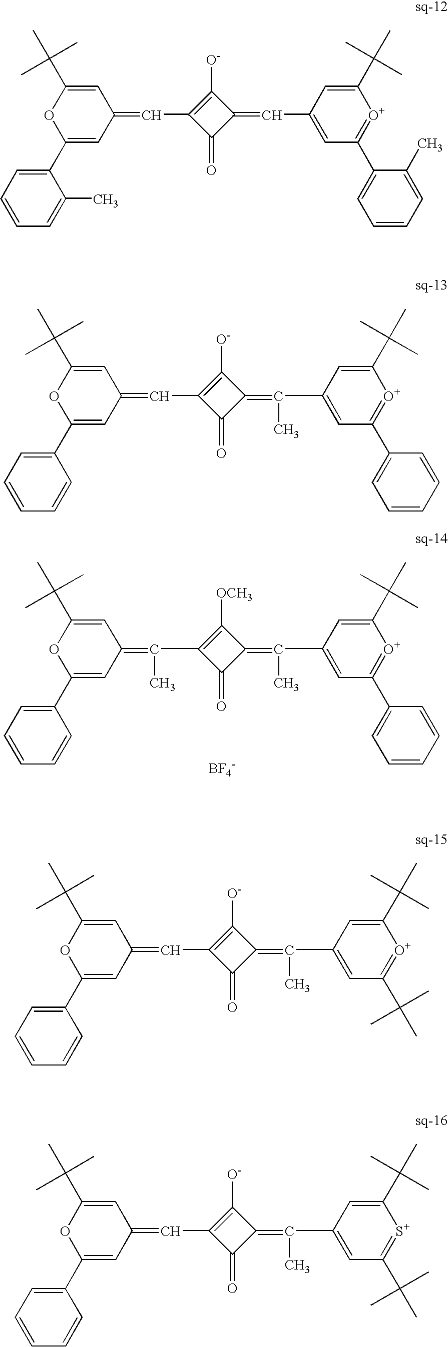

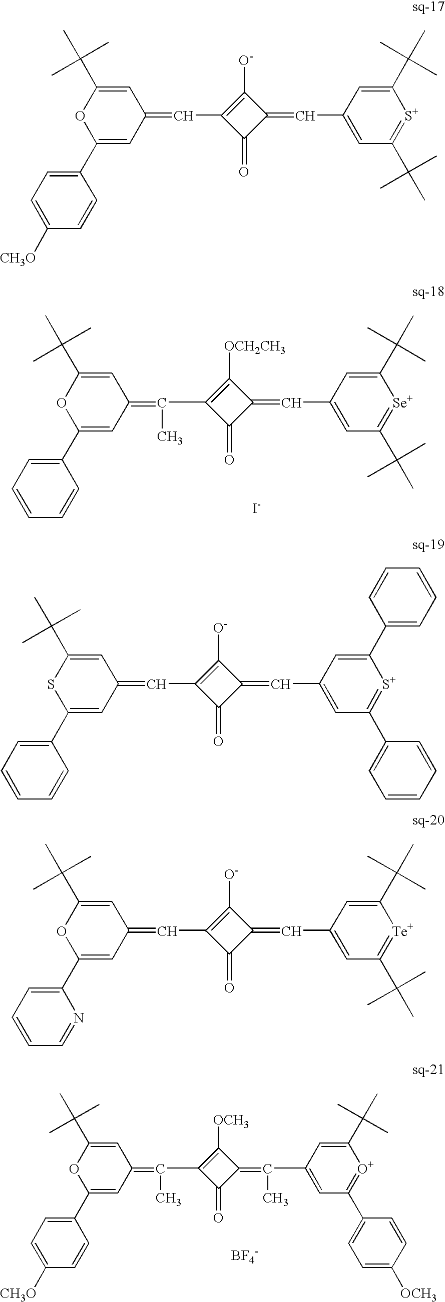

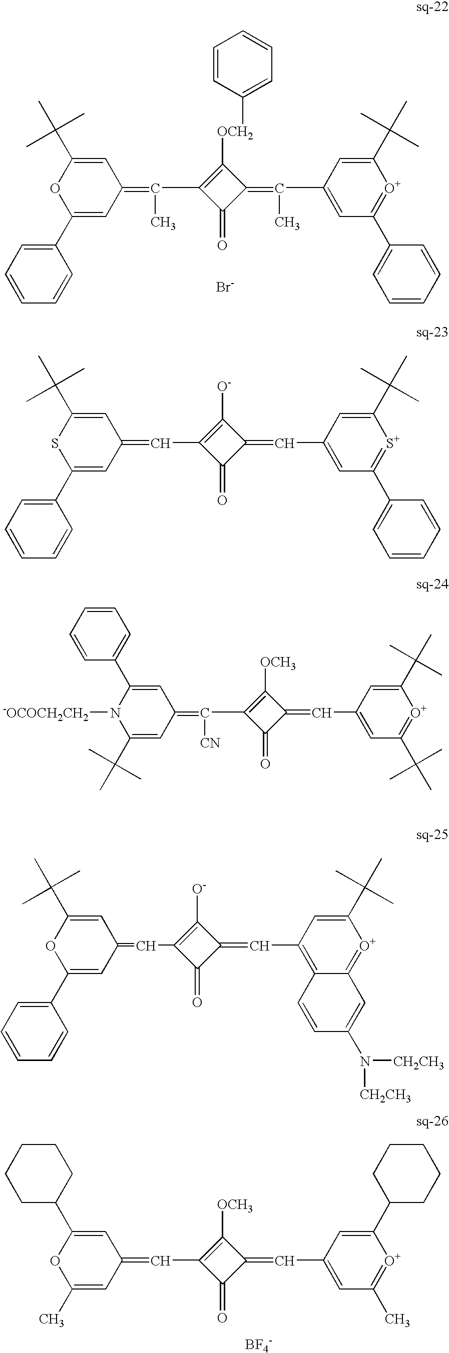

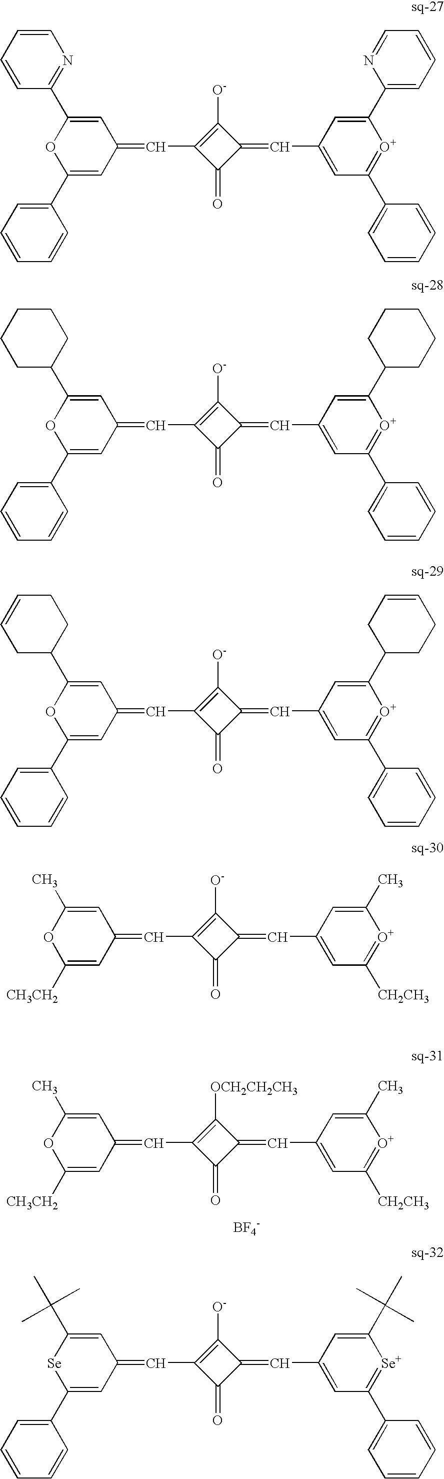

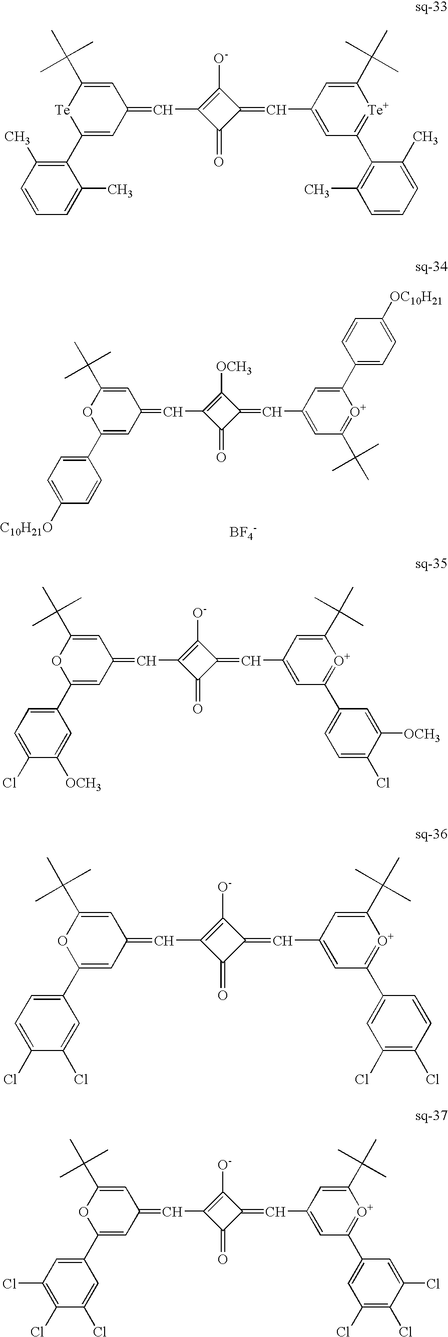

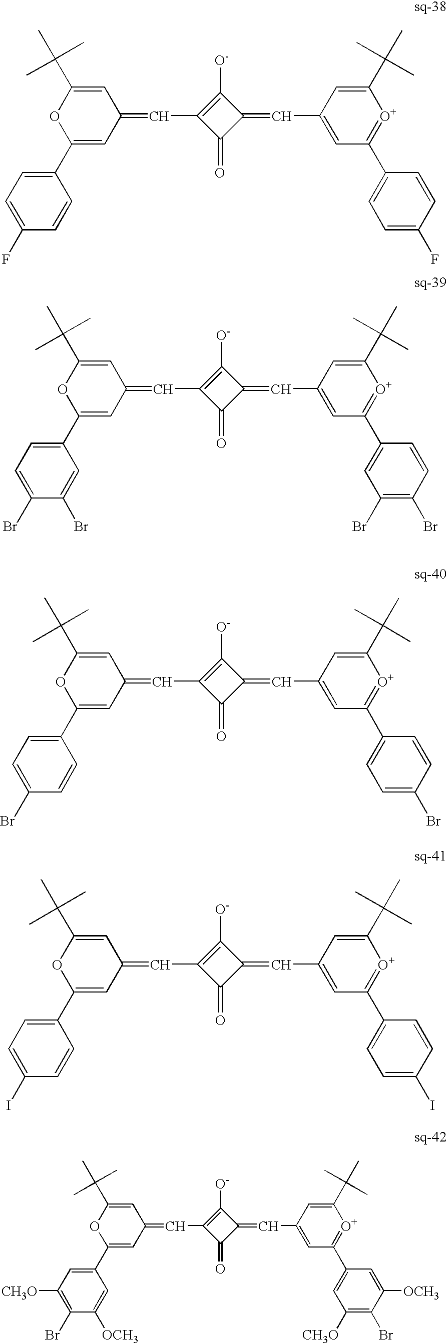

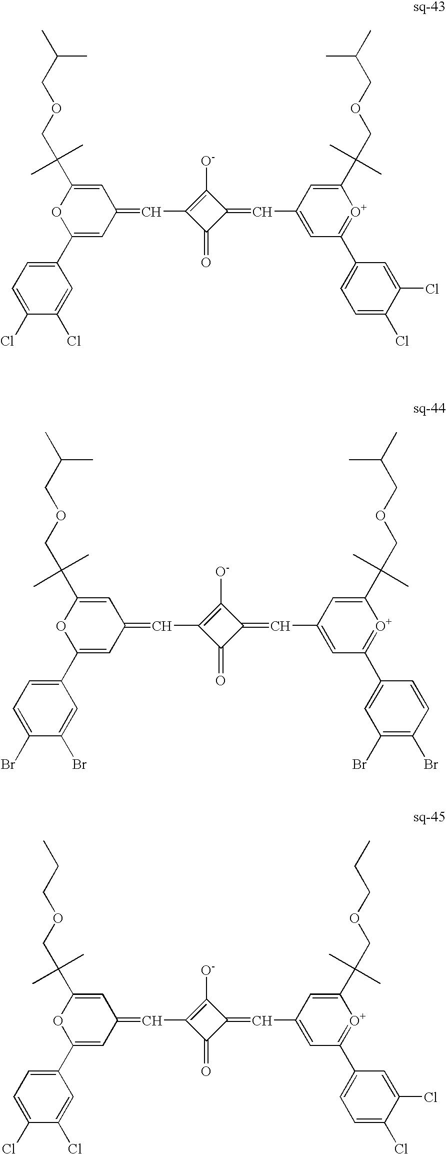

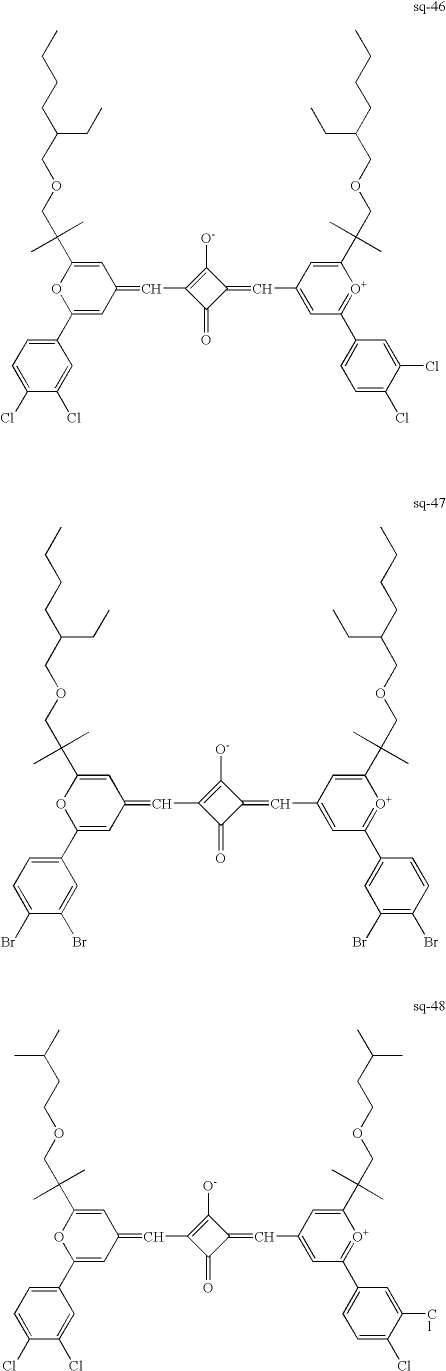

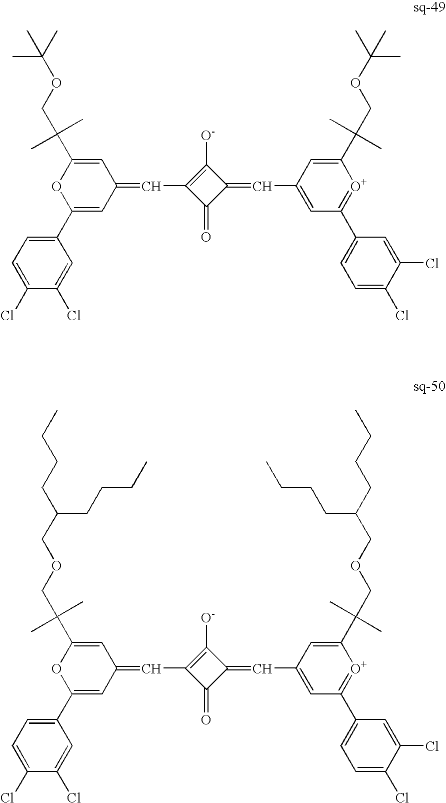

### SYNTHETIC EXAMPLES OF SQUARYLIUM COMPOUND

A synthetic method of squarylium dyes used in the invention will be explained below. The chemical structure of the compounds synthesized below was confirmed by nuclear magnetic resonance spectroscopy and mass spectroscopy.

### Synthetic Example 1

### Exemplified Compound sq-1

Exemplified compound sq-1 was prepared according to the following procedures.

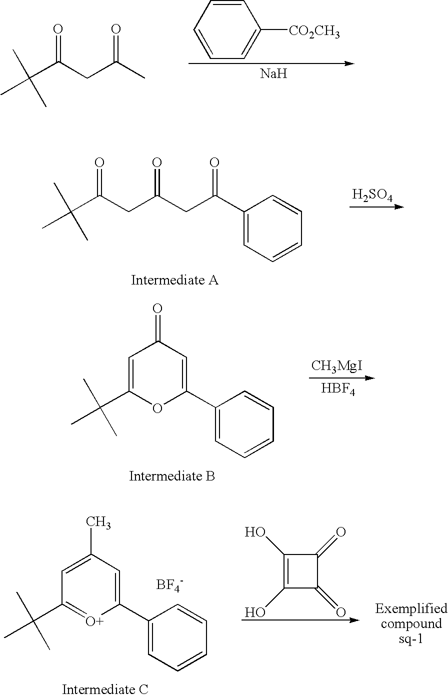

### (Preparation of Intermediate A)

Sodium hydride of 7.0 g was added to 70 ml of ethylene glycol dimethyl ether and the resulting solution was refluxed while heating. To the refluxing solution was dropwise added a solution in which 5.0 g of 5,5-dimethylhexane-2,4-dione (prepared according to the method described in J. Amer. Chem. Soc. 1950, 72, 1352-1356) and 7.2 g of methyl benzoate were dissolved in 70 ml of ethylene glycol dimethyl ether. After the addition the mixture was further refluxed for 6 hours and then cooled to room temperature. The resulting mixture was concentrated under reduced pressure, added with 70 ml of hexane, and cooled with ice water, and 700 ml of water were little by little added thereto. After the water phase of the resulting reaction mixture was washed with hexane at room temperature, and added with concentrated hydrochloric acid to be a pH of 2, the water phase was subjected to extraction employing 200 ml of ethyl acetate. The resulting ethyl acetate phase was dried over sodium sulfate, and filtered off to obtain a filtrate. The solvent of the filtrate was removed under reduced pressure to obtain 6.9 g of Intermediate A.

### (Preparation of Intermediate B)

Intermediate A of 6.9 g was added to 35 ml of sulfuric acid while cooling with ice water, and reacted while stirring at room temperature for one hour. The resulting reaction mixture was dropwise added to 350 ml of water cooled with ice water to produce a crystal. The resulting crystal was filtered off, washed with 50 ml of water, and dried to obtain 6.1 g of Intermediate B.

### (Preparation of Intermediate C)

Intermediate B of 5.0 g was dissolved in 50 ml of tetrahydrofuran under nitrogen atmosphere. The resulting solution was water-cooled and dropwise added with a 0.84 mol/liter methylmagnesium iodide ether solution. The resulting mixture was refluxed for 3 hours while heating. The reaction mixture was cooled with ice water, gradually added with 300 ml of water, and then added with 50 ml of a 42 weight % tetrafluoroboric acid aqueous solution to the resulting solution. The resulting mixture was stirred at room temperature for one hour to produce crystals. The resulting crystals were recrystallized from methanol to obtain 5.1 g of Intermediate C.

### (Preparation of Exemplified Compound sq-1)

Intermediate C of 2.0 g, 0.36 g of 3,4-dihydroxy-3-cyclobutene-1,2-dione and 20 ml of n-propanol were mixed in order, and refluxed for 3 hours while heating. The resulting reaction solution was cooled to room temperature and concentrated under reduced pressure. The concentrated solution was purified according to silica gel column chromatography to obtain 0.3 g of Exemplified compound sq-1.
Mass : m/z 531 (M⁺)
λmax : 773.0 nm (in methyl ethyl ketone)
ε: 222,000 (in methyl ethyl ketone)

### Synthetic Example 2

### Exemplified Compound sq-3

Exemplified compound sq-3 was prepared according to the following procedures.

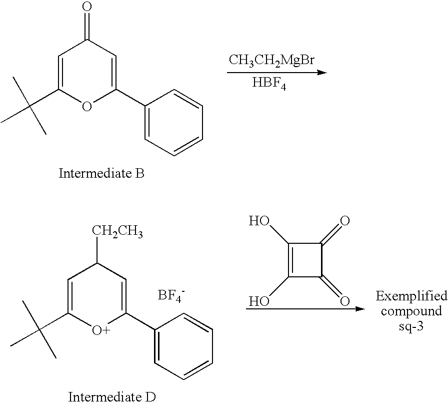

### (Preparation of Intermediate D)

Intermediate B of 5.0 g was dissolved in 50 ml of tetrahydrofuran under nitrogen atmosphere. The resulting solution was water-cooled and dropwise added with a 0.96 mol/liter ethylmagnesium bromide tetrahydrofuran solution. The resulting mixture was refluxed for 3 hours while heating. The reaction mixture was cooled with ice water, gradually added with 500 ml of water, and then added with 50 ml of a 42 weight % tetrafluoroboric acid aqueous solution to the resulting solution. One hundred ml of methylene chloride was added to the mixture, and stirred at room temperature for two hours. The organic phase was separated, dried over magnesium sulfate, and filtered to obtain filtrate. The solvents of the resulting filtrate were removed under reduced pressure to obtain a crystal. The crystal was suspension-washed with ethyl acetate to obtain 4.6 g of Intermediate D.

### (Preparation of Exemplified Compound sq-3)

Intermediate D of 3.0 g, 0.52 g of 3,4-dihydroxy-3-cyclobutene-1,2-dione, 30 ml of n-propanol and 3.2 g of quinoline were mixed in order, and refluxed for 3 hours while heating. The resulting reaction solution was cooled to room temperature to produce crystals. The crystals were separated by filtration and dissolved in 200 ml of methylene chloride. The methylene chloride solution was filtered to obtain filtrate. The solvent of the filtrate was removed under reduced pressure to obtain crystals. The crystals were suspension-washed with methanol to obtain 850 mg of Exemplified compound sq-3.
Mass : m/z 559 (M⁺)
λmax : 819.5 nm (in methyl ethyl ketone)
ε: 150,000 (in methyl ethyl ketone)

### Synthetic Example 3

### Exemplified Compound sq-6

Exemplified compound sq-6 was prepared according to the following procedures.

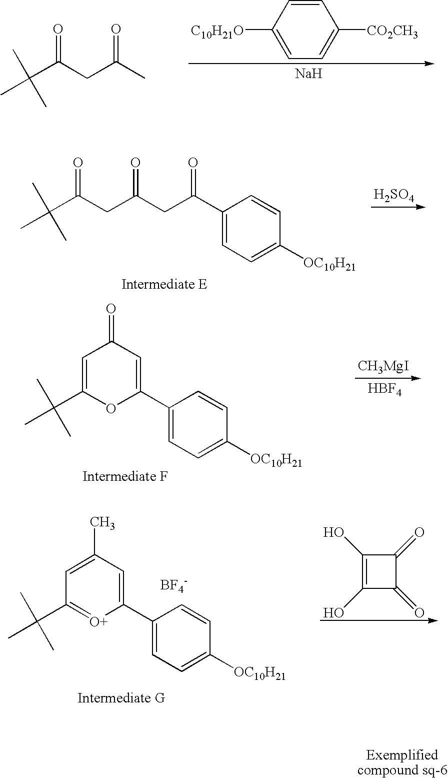

### (Preparation of Intermediate E)

Sodium hydride of 9.8 g was added to 140 ml of ethylene glycol dimethyl ether and the resulting solution was refluxed while heating. To the refluxing solution was dropwise added a solution in which 7.0 g of 5,5-dimethylhexane-2,4-dione (prepared according to the method described in J. Amer. Chem. Soc. 1950, 72, 1352-1356) and 20.5 g of methyl 4-decyloxybenzoate were dissolved in 140 ml of ethylene glycol dimethyl ether. After the addition the mixture was further refluxed for 6 hours and then cooled to room temperature. The resulting mixture was concentrated under reduced pressure, cooled with ice water, and 400 ml of water were little by little added thereto. The resulting reaction mixture was stirred for one hour while cooling with ice water to produce crystals. The resulting crystals were washed with water, and added with 200 ml of ethyl acetate to obtain an ethyl acetate suspension. Two hundred grams of water and concentrated hydrochloric acid were added in order to the ethyl acetate suspension to be a pH of 1. The organic phase of the resulting mixture was separated, dried over sodium sulfate, and filtered to obtain filtrate. The filtrate was concentrated under reduced pressure to produce residue. One hundred grams of hexane were added to the residue to obtain a hexane solution. The resulting hexane solution was stirred for one hour, and filtered to obtain filtrate. The resulting filtrate was stirred for two hours while cooling with ice water to produce crystals. The crystals were separated and dried to obtain 8.8 g of Intermediate E.

### (Preparation of Intermediate F)

Intermediate E of 8.8 g was added to 80 ml of sulfuric acid while cooling with ice water, and reacted while stirring for one hour. The resulting reaction mixture was dropwise added to 800 ml of water cooled with ice water, and further added with 200 ml of ethyl acetate for extraction. The resulting organic phase was dried over magnesium sulfate, and concentrated under reduced pressure to obtain residue. The residue was purified according to silica gel column chromatography to obtain 4.0 g of Intermediate F.

### (Preparation of Intermediate G)

Intermediate F of 2.8 g was dissolved in 28 ml of tetrahydrofuran under nitrogen atmosphere. The resulting solution was water-cooled and dropwise added with 13 ml of a 0.84 mol/liter methylmagnesium iodide ether solution. The resulting mixture was refluxed for 3 hours while heating. The reaction mixture was cooled with ice water, gradually added with 140 ml of water, and then added with 28 ml of a 42 weight % tetrafluoroboric acid aqueous solution to the resulting solution. The resulting mixture was stirred at room temperature for two hours to produce crystals. The resulting crystals were recrystallized from hexane to obtain 2.4 g of Intermediate G.

### (Preparation of Exemplified Compound sq-6)

Intermediate G of 2.4 g, 0.28 g of 3,4-dihydroxy-3-cyclobutene-1,2-dione, 25 ml of n-propanol and 1.7 g of quinoline were mixed in order, and refluxed for 3 hours while heating. The resulting reaction solution was cooled to room temperature, and stirred for 3 hours to produce crystals. The crystals were separated by filtration and dissolved in 50 ml of methylene chloride. The methylene chloride solution was washed with 50 ml of water, dried over sodium sulfate filtered to obtain filtrate. The solvent of the filtrate was removed under reduced pressure to obtain residue. The residue was suspension-washed with ethanol to obtain 1.0 g of Exemplified compound sq-6.
Mass : m/z 844 (M⁺)
λmax : 779.5 nm (in methyl ethyl ketone)
ε: 287,000 (in methyl ethyl ketone)

### Synthetic Example 4

### Exemplified Compound sq-36

Exemplified compound sq-6 was prepared according to the following procedures.

$$\begin{matrix}Exemplified \\ compound sq \text{-} 6\end{matrix} {}^{{( {CH}_{3} O )}_{2} {SO}_{2} / {CH}_{2} {Cl}_{2}} \begin{matrix}Exemplified \\ compound sq \text{-} 34\end{matrix}$$

### Exemplified compound sq-6 Exemplified compound sq-36

### (Preparation of Intermediate D)

Exemplified compound sq-6 of 1.7 g was dissolved in 18 ml of methylene chloride, added with 1.5 g of dimethyl sulfate, and refluxed for 6 hours while heating. The resulting reaction mixture was stirred for 6 hours at room temperature, gradually added with 1.9 g of a 28% by weight sodium methoxide methanol solution, and further stirred for 4 hours. Thereafter, 15 ml of water and 3.5 ml of a 42 weight % tetrafluoroboric acid aqueous solution were added in order to the resulting solution, and stirred for additional one hour. The organic phase was separated, dried over sodium sulfate, and filtered to obtain filtrate. The solvents of the resulting filtrate were removed under reduced pressure to obtain crystals. The crystals were recrystallized from a mixture of methylene chloride and diisopropyl ether. Thus, 1.6 g of sq-36 were obtained.
Exemplified compound sq-36
λmax : 784.5 nm (in methyl ethyl ketone)
ε: 224,000 (in methyl ethyl ketone)

Other squarylium dyes were synthesized in the same manner as above.
Exemplified compound sq-43)
λmax : 785.5 nm (in methyl ethyl ketone)
ε: 236,000 (in methyl ethyl ketone)

The squarylium dye content of the image formation layer in the invention is preferably from 0.1 to 10% by weight and more preferably from 0.3 to 5% by weight in view of sensitivity, developability and printing durability.

The optical density to the wavelength of laser light for exposure of the image formation layer in the invention is from 0.1 to 2.0. The optical density of less than 0.1 results in poor sensitivity, while the optical density exceeding 2.0 lowers developability or printing durability.

### (Hydrophilic Support)

As the hydrophilic support in the invention, there are a plate of a metal plate such as aluminum, zinc, copper or stainless steel; a film of a plastic such as polyethylene terephthalate, polycarbonate, polyvinyl acetal, or polyethylene; a paper sheet melt-coated with synthetic resin or coated with a synthetic resin solution; a composite sheet in which a metal film is provided on the plastic film according to lamination or vacuum evaporation; and another plate used for the support of a conventional planographic printing plate material.

Among these, an aluminum plate or an aluminum film coated composite is preferred in view of strength, weight or handling properties.

The thickness of the support is preferably from 100 to 350 μm, and more preferably from 150 to 300 μm.

The Aluminum plate is preferably subjected to surface treatment in order to increase high water retention, and adhesion to an image formation layer which is to be provided on it. Examples of the surface treatment include surface-roughening treatments such as a brush graining method, a ball graining method, an electrolytically etching method, a chemically etching method, a liquid horning graining method, a sand-blast graining method and their combination. Among these, surface roughening treatment including the electrolytically etching method is preferred. The electrolyte solution used in the electrolytically etching method is an aqueous solution or organic solvent containing aqueous solution containing an acid, an alkali or a salt. Among these, an electrolyte solution containing hydrochloric acid or hydrochloride is preferred. The surface roughened aluminum plate is optionally subjected to desmut treatment with an acid or alkali solution. It is preferred that the resulting aluminum plate is further subjected to anodization treatment. A solution used for anodization treatment is preferably an aqueous solution containing sulfuric acid or phosphoric acid.

The coating amount of the anodization layer formed by anodization treatment above is preferably from 2.0 to 6 g/m², and more preferably from 2.5 to 5 g/m².

The anodization layer can be surface-treated with silicate, potassium fluorozirconate, phosphomolybdate, polyacrylic acid, polyvinyl sulfonic acid, phosphonic acid or polyvinyl phosphonic acid.

### <Alkali Soluble Binder>

An alkali soluble binder can be used in the positive or negative working image formation layer (hereinafter also referred simply to as light sensitive layer) of the planographic printing plate material of the invention. Examples of the binder include a novolak resin, a polymer containing a hydroxystyrene unit, a polymer containing a structural unit represented by formula ASP described below, and another conventional acryl resin.

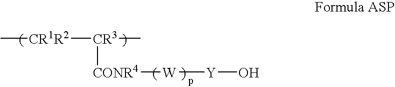

In formula ASP, R¹ and R² independently represent a hydrogen atom, an alkyl group such as methyl or ethyl or a carboxyl group, and preferably a hydrogen atom; R³ represents a hydrogen atom, a halogen atom such as chlorine or bromine or an alkyl group such as methyl or ethyl, and preferably a hydrogen atom or methyl; R⁴ represents a hydrogen atom, an alkyl group such as methyl, an aryl group such as a phenyl group or a naphthyl group; Y represents a substituted or unsubstituted phenylene or naphthylene group, the substituent including an alkyl group such as methyl or ethyl, a halogen atom such as chlorine or bromine; a carboxyl group, an alkoxy group such as methoxy or ethoxy, a hydroxy group, a sulfonic acid group, a cyano group, a nitro group or an acyl group, and preferably a unsubstituted phenylene or naphthylene group or a methyl substituted phenylene or naphthylene group; W represents an organic divalent linkage group; and p is an integer of 0 to 5, and p is preferably 0.

The polymer containing a structural unit represented by formula ASP refers to a homopolymer containing only the structural unit represented by formula ASP and a copolymer containing the structural unit represented by formula ASP and a monomer unit formed by cleavage of a polymerizable double bond of another vinyl monomer.

Examples of the polymer having a structural unit represented by formula ASP include polymers represented by the following formulas (a) through (h):

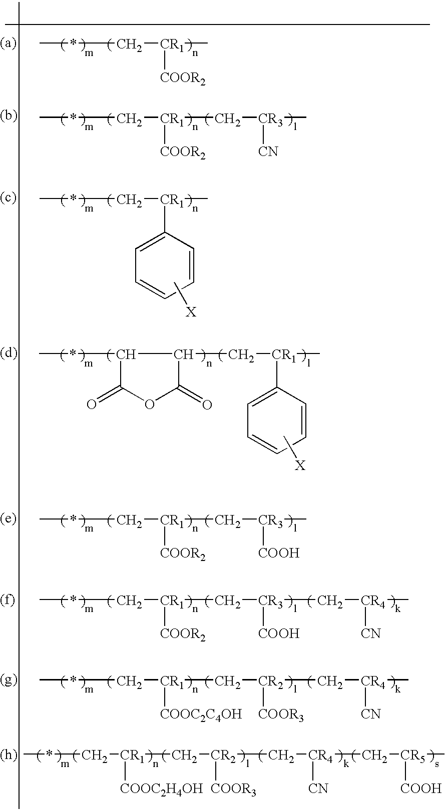

In formulas (a) through (h) above, (*) represents the structural unit represented by formula ASP described previously.

In formulas (a) through (h) above, R₁ through R₅ independently represent a hydrogen atom, an alkyl group or a halogen atom; X represents an alkyl group or a halogen atom; and m, n, l, k and s represent mol % .

Examples of the novolak resin include a phenol-formaldehyde resin, a cresol-formaldehyde resin, a phenol-cresol-formaldehyde resin disclosed in Japanese Patent O.P.I. Publication No. 55-57841 and a polycondensation resin of a p-substituted phenol or phenol and cresol with formaldehyde disclosed in Japanese Patent O.P.I. Publication No. 55-127553.

Examples of the polymer containing a hydroxystyrene unit include a homopolymer or copolymer of hydroxystyrene disclosed in Japanese Patent Publication No. 52-41050.

The novolak resin, the poly(hydroxystyrene), the polymer having a structural unit represented by formula ASP and another conventional acryl resin can be used in combination.

The alkali soluble binder content of the light sensitive layer in the invention is preferably from 20 to 90% by weight.

In the invention, the alkali soluble binder is preferably the novolak resin, in effectively attaining the object of the invention.

### <Cross-Linking Agent>

In the invention, the cross-linking agent in the invention is a compound having a group cross-linking by action of an acid, and used in the negative working planographic printing plate material. The cross-linking agent in the invention is a compound cross-linking the alkali soluble resin by action of an acid, and lowers alkali solubility of the cross-linked alkali soluble resin.

Examples of he cross-linking agent include a compound having a methylol group or a methylol derivative group, a melamine resin, a furan resin, an isocyanate, and a blocked isocyanate (an isocyanate having a protective group). These cross-linking agents may be used as an admixture of two or more kinds thereof. The cross-linking agent is preferably a compound having a methylol group or an acetoxymethyl group. In the invention, melamine resin is especially preferred as the cross-linking agent.

The content of the cross-linking agent in the light sensitive layer is preferably 5 to 70% by weight.

### (Compound Generating an Acid by Heat)

Examples of the compound generating an acid by heat (hereinafter also referred to as acid generation compound) include onium salts such as a diazonium salt, an ammonium salt, a phosphonium salt, a sulfonium salt and an iodonium salt; and an organic halogen-containing compound. The diazonium salt or a trihaloalkyl-containing compound is preferred in obtaining high sensitivity. These acid generation compounds may be used as an admixture of two or more kinds thereof.

As the trihaloalkyl-containing compound, trihalomethyl-s-triazines, trihalomethyl-oxadiazoles or tribromomethylsulfonyl compounds disclosed in U.S. Pat. No. 4,239,850 are preferred.

The acid generation compound is an organic halogen-containing compound in view of sensitivity to infrared rays and storage stability of an image forming material using it. The organic halogen-containing compound is preferably a halogenated alkyl-containing triazines or a halogenated alkyl-containing oxadiazoles. Of these, halogenated alkyl-containing s-triazines are especially preferable. Examples of the halogenated alkyl-containing oxadiazoles include 2-halomethyl-1,3,4-oxadiazole compounds disclosed in Japanese Patent O.P.I. Publication Nos. 54-74728, 55-24113, 55-77742, 60-3626 and 60-138539. Preferable examples of the 2-halomethyl-1,3,4-oxadiazole compounds are listed below.

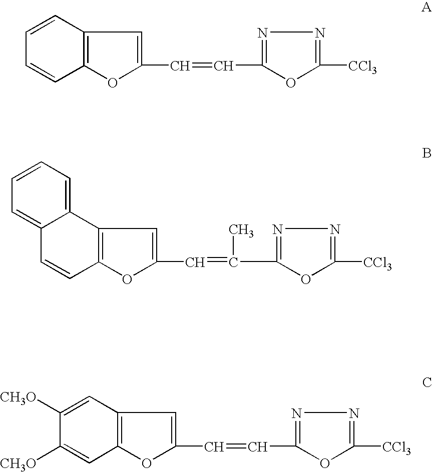

The halogenated alkyl containing triazine compound is preferably a compound represented by the following formula TZN:

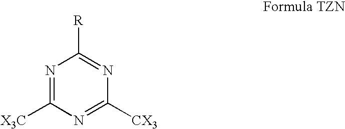

wherein R represents an alkyl group, a halogenated alkyl, an alkoxy group, a substituted or unsubstituted styryl group, or a substituted or unsubstituted aryl group (for example, phenyl or naphthyl); and X represents a halogen atom.

Examples of the triazine compound represented by formula TZN will be listed below.

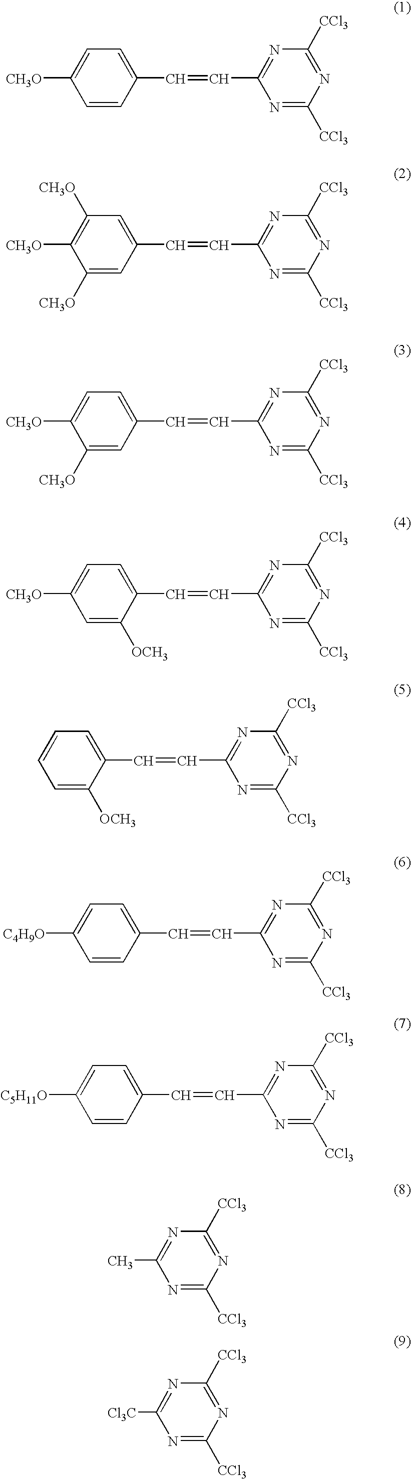

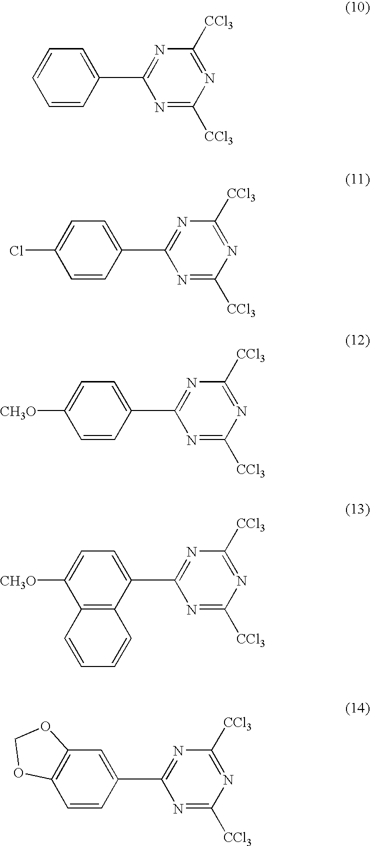

The content of the acid generation compound in the light sensitive layer of the negative working planographic printing plate material is preferably from 0.01 to 50% by weight, and more preferably from 0.1 to 20% by weight, in view of cross-linking properties, sensitivity and printing durability.

### <Acid Decomposable Compound>

In the invention, an acid decomposable compound (a compound having a chemical bond capable of being decomposed by an acid) is preferably used in the positive working planographic printing plate material. Examples of the acid decomposable compound in the invention include a compound having a C—O—C bond disclosed in Japanese Patent O.P.I. Publication Nos. 48-89003, 51-120714, 53-133429, 55-12995, 55-126236 and 56-17345, a compound having a Si—O—C bond disclosed in Japanese Patent O.P.I. Publication Nos. 60-37549 and 60-121446, another acid decomposable compound disclosed in Japanese Patent O.P.I. Publication Nos. 60-3625 and 60-10247, a compound having a Si—N bond disclosed in Japanese Patent O.P.I. Publication No. 62-222246, a carbonic acid ester disclosed in Japanese Patent O.P.I. Publication No. 62-251743, an orthocarbonic acid ester disclosed in Japanese Patent O.P.I. Publication No. 62-2094561, an orthotitanic acid ester disclosed in Japanese Patent O.P.I. Publication No. 62-280841, an orthosilicic acid ester disclosed in Japanese Patent O.P.I. Publication No. 62-280842, an acetal or ketal disclosed in Japanese Patent O.P.I. Publication No. 63-10153 and a compound having a C—S bond disclosed in Japanese Patent O.P.I. Publication No. 62-244038.

Of these compounds, the compound having a C—O—C bond, the compound having a Si—O—C bond, the orthocarbonic acid esters, the acetals or ketals or the silylethers disclosed in Japanese Patent O.P.I. Publication Nos. 53-133429, 56-17345, 60-121446, 60-37549, 62-209451 and 63-10153 are preferable. Of these compounds is especially preferable a polymer disclosed in Japanese Patent O.P.I. Publication No. 53-133429 which has a repeated acetal or ketal group in the main chain and increasing solubility in a developer by action of an acid or a compound disclosed in Japanese Patent O.P.I. Publication No. 63-10153.

The acid decomposable compound is preferably a compound represented by the following formula ADC-1:

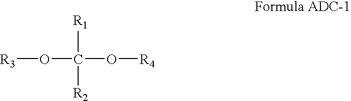

wherein R₁, R₂, R₃ and R₄ independently represent a hydrogen atom, an alkyl group, a cycloalkyl group, or an aryl group, provided that two of R₁, R₂, R₃ and R₄ may combine with each other to form a ring.

The acid decomposable compound is more preferably a compound represented by the following formula ADC-2:

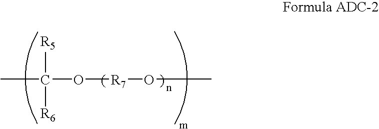

wherein R₅ and R₆ independently represent a hydrogen atom, an alkyl group, a cycloalkyl group, or an aryl group, provided that two of R₅ and R₆ may combine with each other to form a ring; R₇ represents an alkylene group, a cycloalkylene group or an arylene group; and n and m independently represent an integer of not less than 1.

These acid decomposable compounds may be used as an admixture of two or more kinds thereof.

The content of the acid decomposable compound in the light sensitive layer of the positive working planographic printing plate material is preferably from 5 to 70% by weight, and more preferably from 10 to 50% by weight.

Preferred examples of the acid decomposable compound will be listed below.

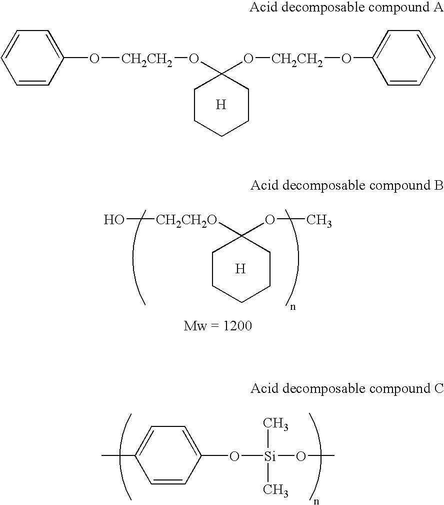

### (Coating)

Solvents used for preparing a light sensitive layer coating liquid include alcohols such as methanol, ethanol, propanol, isopropanol, sec-butanol, isobutanol, hexanol, benzyl alcohol, diethylene glycol, triethylene glycol, tetraethylene glycol and 1,5-pentane diol; ethers such as propylene glycol monomethyl ether, propylene glycol monoethyl ether acetate, propylene glycol monoethyl ether, propylene glycol monobutyl ether, dipropylene glycol monomethyl ether and tripropylene glycol monomethyl ether; ketones such as acetone, methyl ethyl ketone, methyl isobutyl ketone, diacetone alcohol, cyclopentanone, dioxolane, cyclohexanone, methyl cyclohexanone and y-butyrolactone; and esters such as ethyl lactate, butyl lactate, diethyl oxalate, methyl benzoate and ethyl acetate.

In the invention, among these solvents, ketones are preferred.

The light sensitive layer coating liquid is coated on the support according to a conventional coating method, and dried to obtain a light sensitive planographic printing plate material. The coating methods include an air doctor coating method, a blade coating method, a wire bar coating method, a knife coating method, a dip coating method, a reverse roll coating method, a gravure coating method, a cast coating method, a curtain coating method and an extrusion coating method. The coated light sensitive layer is dried at a temperature of preferably at 60 to 160° C., more preferably 80 to 140° C. and still more preferably 90 to 120° C.

### (Plate-Making and Printing)

The light sensitive planographic printing plate material of the invention is imagewise exposed to form an image, and then optionally developed to obtain a planographic printing plate, which is applied for printing.

Imagewise exposure is carried out employing a light source emitting light with an emission wavelength of not shorter than 700 nm. The light sources for the imagewise exposure include, for example, a semiconductor laser, a He—Ne laser, a YAG laser, and carbon dioxide gas laser. The output power of the light sources is ordinarily not less than 50 mW, and preferably not less than 100 mW.

When the light sensitive planographic printing plate material is imagewise exposed at one time, a mask material having a negative image pattern made of a light shielding material is provided on the image formation layer to be in close contact with the image formation layer, and exposure is carried out through the mask.

When an array light such as an emission diode array is used or exposure using a halogen lamp, a metal halide lamp or a tungsten lamp is controlled using an optical shutter material such as liquid crystal or PLZT, a digital exposure according to an image signal is possible and preferable. In this case, direct writing is possible without using any mask material.

When a laser is used for exposure, which can be condensed in the beam form, scanning exposure according to an image can be carried out, and direct writing is possible without using any mask material. When the laser is employed for imagewise exposure, a highly dissolved image can be obtained, since it is easy to condense its exposure spot in minute size.

A laser scanning method by means of a laser beam includes a method of scanning on an outer surface of a cylinder, a method of scanning on an inner surface of a cylinder and a method of scanning on a plane. In the method of scanning on an outer surface of a cylinder, laser beam exposure is conducted while a drum around which a recording material is wound is rotated, in which main scanning is represented by the rotation of the drum, while sub-scanning is represented by the movement of the laser beam. In the method of scanning on an inner surface of a cylinder, a recording material is fixed on the inner surface of a drum, a laser beam is emitted from the inside, and main scanning is carried out in the circumferential direction by rotating a part of or an entire part of an optical system, while sub-scanning is carried out in the axial direction by moving straight a part of or an entire part of the optical system in parallel with a shaft of the drum. In the method of scanning on a plane, main scanning by means of a laser beam is carried out through a combination of a polygon mirror, a galvano mirror and an Fθ lens, and sub-scanning is carried out by moving a recording medium. The method of scanning on an outer surface of a cylinder, and the method of scanning on an inner surface of a cylinder are preferred in optical system accuracy and high density recording.

When the exposed light sensitive planographic printing plate material is developed, an automatic developing machine is ordinarily used.

The planographic printing plate material of the invention is developed with a developer to obtain a planographic printing plate. The developer is preferably an aqueous alkaline developer. As the aqueous alkaline developer, there is, for example, an aqueous solution containing an alkali metal salt such as sodium hydroxide, potassium hydroxide, sodium carbonate, potassium carbonate, sodium metasilicate, potassium metasilicate or di or trisodium phosphate. The metal salt concentration of the developer is preferably 0.05 to 20% by weight, and more preferably 0.1 to 10% by weight. The developer optionally contains an anionic surfactant, an amphoteric surfactant or an organic solvent such as alcohol. The organic solvent includes propylene glycol, ethylene glycol monophenyl ether, benzyl alcohol and n-propyl alcohol.

The developer temperature is preferably from 15 to 40° C, and preferably from 25 to 35° C. The developing time is preferably from 1 second to 2 minutes, and more preferably from 10 to 45 seconds.

If necessary, the light sensitive layer surface can be rubbed with a brush or a molleton during development. The developed surface of the developed planographic printing plate material is washed with water and/or desensitized with an aqueous desensitizing solution.

Examples of the aqueous desensitizing solution include an aqueous solution of natural water-soluble polymers such as gum arabic, dextrin and carboxymethylcellulose or synthetic water-soluble polymers such as polyvinyl alcohol, polyvinyl pyrrolidone, and polyacrylic acid.

The aqueous desensitizing solution may optionally contain an acid or a surface-active agent. The desensitized planographic printing plate is dried and applied for printing.

Printing is carried out employing a conventional printing press.

In recent years, printing ink containing no petroleum volatile organic compound (VOC) has been developed and used in view of environmental concern. The present invention provides excellent effects in employing such a printing ink. Examples of such a printing ink include soybean oil ink “Naturalith 100” produced by Dainippon Ink Kagaku Kogyo Co., Ltd., VOC zero ink “TK HIGH ECO NV” produced by Toyo Ink Manufacturing Co., Ltd., and process ink “Soycelvo” produced by Tokyo Ink Co., Ltd.

The present invention will be explained in detail below employing examples, but is not limited thereto.

### EXAMPLE 1

### (Preparation of Support)

A 0.24 mm thick aluminum plate (material 1050, quality H16) was degreased at 60° C. for one minute in an aqueous 5% sodium hydroxide solution, and subjected to electrolytic etching at 25° C., at a current density of 3 A/dm² for 30 seconds in an aqueous 0.5 mol/liter hydrochloric acid solution.

Thereafter, the resulting plate was subjected to desmut treatment at 60° C. for 10 seconds in an aqueous 5% sodium hydrophilic solution, and to anodization treatment at 20° C., at a current density of 3 A/dm² for one minute in an aqueous 20% sulfuric acid solution to form an anodization layer with a coating amount of 3.5 g/m².

The anodized aluminum plate was subjected to hot water sealing treatment to prepare an aluminum support for a planographic printing plate material.

### (Preparation of Planographic Printing Plate Material Sample)

### 1. Negative Working Planographic Printing Plate Material Sample

The following negative working light sensitive composition was coated on the aluminum support obtained above through a wire bar to form a light sensitive layer with a dry thickness of 1.5 g/m², and stored for 60 seconds in an 80° C. warm air circulation type drier for drying. Thus, a planographic printing plate material sample N-1 was obtained. Negative working light sensitive composition

| | |
|---|---|
| Novolak resin DULITE PD-140 | 82 weight parts |
| (produced by Boden Co., Ltd.) | |
| Cross-linking agent CYMEL 303LF | 8 weight parts |
| (produced by Mitsui Cynide Co., Ltd.) | |
| Acid generation compound | 6 weight parts |
| (Exemplified compound 8 Triazine-S) | |
| Infrared absorbent | 3 weight parts |
| (Exemplified compound IRD1) | |
| Visualization dye OIL BLUE 613 | 1 weight part |
| (produced by Orient Kagaku Kogyo | |
| Co., Ltd.) | |
| Cyclohexanone | 1000 weight parts |

The resulting planographic printing plate material sample N-1 was mounted on a CTP setter equipped with a semiconductor laser head, PTR-4300 (manufactured by Dainippon Screen Manufacturing Co., Ltd.), and imagewise exposed at a drum rotation number of 1000 rpm and at a resolution of 2400 dpi while changing the laser output power to form a dot image with a screen line number of 175 lines. Herein, “dpi” means a dot number per 1 inch or 2.54 cm.

The exposed sample was heated at 105° C. for 3 minutes in an oven. Employing an automatic developing machine PK-910 (manufactured by Kodak Polychrome Graphics Co., Ltd.), the heated sample was developed with a developer at 30° C. for 25 seconds, the developer being obtained by diluting a developer PDI (manufactured by Kodak Polychrome Graphics Co., Ltd.) with water by a factor of 6. Thus, a planographic printing plate sample n-1 was obtained.

### 2. Positive Working Planographic Printing Plate Material Sample

The following positive working light sensitive composition was coated on the aluminum support obtained above through a wire bar to form a light sensitive layer with a dry thickness of 2.0 g/m², and stored for 60 seconds in a 120° C. warm air circulation type drier for drying. Thus, a planographic printing plate material sample P-1 was obtained.

### Positive Working Light Sensitive Composition

| | |
|---|---|
| Novolak resin* | 70 weight parts |
| Acid decomposable compound A | 20 weight parts |
| Acid generation compound | 6 weight parts |
| (Exemplified compound 8 Triazine-S) | |
| Infrared absorbent | 3 weight parts |
| (Exemplified compound IRD1) | |
| Visualization dye OIL BLUE 613 | 1 weight part |
| (produced by Orient Kagaku Kogyo | |
| Co., Ltd.) | |
| Propylene glycol monomethyl ether | 1000 weight parts |

*Polycondensation product of a mixture of phenol and a mixed m- and p-cresol with formaldehyde (phenol:m-cresol:p-cresol = 20:48:32 by mole, Mn = 500, Mw = 2500)

The resulting planographic printing plate material sample P-1 was mounted on a CTP setter equipped with a semiconductor laser head, PTR-4300 (manufactured by Dainippon Screen Manufacturing Co., Ltd.), and imagewise exposed at laser output power of from 30 to 100% at a drum rotation number of 1000 rpm at a resolution of 2400 dpi to form a dot image with a screen line number of 175 lines.

Employing an automatic developing machine Raptor 85 Thermal (manufactured by GLUNZ & JENSEN Co., Ltd.), the exposed sample was developed with the following developer at 30° C. for 30 seconds. Thus, a planographic printing plate sample was obtained.

TABLE 1
Developer

| Materials used | Amount |
|---|---|
| Pure water | 896.0 g |
| Potassium silicate A 40% solution | 87.8 g |
| (produced by Nippon Kagaku Co., Ltd.) | |
| Potassium hydroxide 50% solution | 61.1 g |
| (produced by Toho Kagaku Co., Ltd.) | |
| Trilon M Liquid 40% solution | 1.4 g |
| (produced by BASF) | |

### EXAMPLE 2

Planographic printing plate material samples N-2, N-3, N-4, N-5, N-6, N-8 and N-9 were prepared in the same manner as in planographic printing plate material sample N-1 of Example 1, except that the infrared absorbents or acid generation compounds were changed to those shown in Table 2.

Planographic printing plate material samples P-2, P-3, P-4, P-5, P-6, P-7, P-9 and P-10 were prepared in the same manner as in planographic printing plate material sample P-1 of Example 1, except that the infrared absorbents, acid generation compounds or acid decomposable compounds were changed to those shown in Table 2.

TABLE 2

| Planographic | | | |
|---|---|---|---|
| printing plate | | Acid | Acid |
| material Sample | Infrared | generation | decomposable |
| No. | absorbent | compound | compound |
| N-2 | P-1 | 1 | — |
| N-3 | P-1 | 3 | — |
| N-4 | P-1 | 12 | — |
| N-5 | P-4 | 1 | — |
| N-6 | P-4 | 8 | — |
| N-7 | Sq-3 | 8 | — |
| N-9 | Sq-43 | 8 | — |
| P-2 | P-1 | 8 | B |
| P-3 | P-1 | 8 | C |
| P-4 | P-1 | 12 | A |
| P-5 | P-4 | 1 | A |
| P-6 | P-4 | 8 | A |
| P-7 | P-4 | 12 | A |
| P-9 | Sq-3 | 8 | A |
| P-10 | Sq-43 | 8 | A |

### COMPARATIVE EXAMPLE N-7 was

Planographic printing plate material sample N-7 was prepared in the same manner as in planographic printing plate material sample N-1 of Example 1, except that the infrared absorbent was changed to Comparative dye C as shown below.

Planographic printing plate material sample P-8 was prepared in the same manner as in planographic printing plate material sample P-1 of Example 1, except that the infrared absorbent was changed to Comparative dye C as shown below.

Each of the resulting planographic printing plate material samples N-7 and P-8 was imagewise exposed and developed in the same manner as in Example 1.

### Comparative Dye C

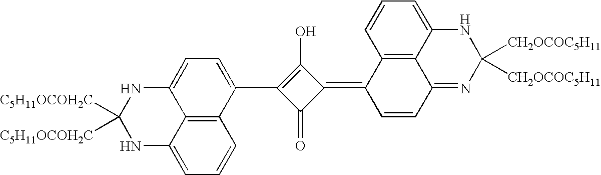

### Compound Described in Japanese Patent Publication No. 2-216140

### <Evaluation>

### (Sensitivity)

The negative working planographic printing plate material sample was exposed in the same manner as in sample N-1 of Example 1, except that the exposure was carried out varying laser light exposure energy, and developed in the same manner as in sample N-1 of Example 1 to obtain solid images. The optical density of the resulting solid images was measured through a densitometer D196 (produced by GRETAG Co., Ltd.). The exposure energy providing 95% of the saturated optical density was defined as sensitivity of the negative working planographic printing plate material sample.

The positive working planographic printing plate material sample was exposed in the same manner as in sample P-1 of Example 1, except that the exposure was carried out varying laser light exposure energy, and developed in the same manner as in sample P-1 of Example 1 to obtain image portions and non-image portions. The optical density of the resulting non-image portions was measured through a densitometer D196 (produced by GRETAG Co., Ltd.). The exposure energy providing an optical density of the support (uncoated) surface optical density plus 0.01 was defined as sensitivity of the positive working planographic printing plate material sample.

### (Printing Durability)

Each of the planographic printing plate material samples obtained above was imagewise exposed and developed in the same manner as in Example 1, except that the exposure was carried out at energy which is 1.3 times the energy providing sensitivity. Thus, a printing plate sample was obtained. The resulting printing plate sample was mounted on a press DAIYA1F-1 (produced by Mitsubishi Jukogyo Co., Ltd.), and printing was carried out, where coated paper sheets, printing ink soybean oil ink Naturalith 100 (produced by Dainippon Ink Kagaku Kogyo Co., Ltd.), and dampening solution H solution SG-51 ( concentration: 1.5%, produced by Tokyo Ink Co., Ltd.) were employed for printing. Whenever 500 prints were obtained, printing was stopped, and the printing plate surface was cleaned with a plate cleaner Ultra Plate Cleaner (produced by available from Dainichi Seika Co., Ltd.), and then printing was restarted (one cycle). This process was repeated and the number of cycles at which lack of small dots with a dot area of 3% on the resulting prints was observed was evaluated as a measure of printing durability.

### (Anti-Stain Property)

A printing plate sample was obtained in the same manner as above. The resulting printing plate sample was mounted on a press DAIYA1F-1 (produced by Mitsubishi Jukogyo Co., Ltd.), and printing was carried out, where coated paper sheets, printing ink soybean oil ink Naturalith 100 (produced by Dainippon Ink Kagaku Kogyo Co., Ltd.), and dampening solution H solution SG-51 (concentration: 1.5%, produced by Tokyo Ink Co., Ltd.) were employed for printing. When ten thousand prints were obtained, printing was stopped, allowed to stand for 3 hours, and then printing was restarted. The number of prints printed until ink stains at non-image portions of the printing plate were completely removed was determined as a measure of an anti-stain property. The less the number is, the better the anti-stain property. The antistain property was evaluated according to the following criteria:
A: The number was not more than 50.
B: The number was from 51 to 100.
C: The number was from 101 to 200.
D: The number was more than 200.

The results are shown in Table 3.

TABLE 3

| | | Printing | Anti-stain | |
|---|---|---|---|---|
| Sample | Sensitivity | Durability | Property | |
| No. | (mj/cm²) | (Cycle Number) | (Number) | Remarks |
| N-1 | 60 | 21 | A | Inventive |
| N-2 | 80 | 18 | B | Inventive |
| N-3 | 90 | 19 | B | Inventive |
| N-4 | 110 | 20 | A | Inventive |
| N-5 | 60 | 19 | B | Inventive |
| N-6 | 110 | 22 | B | Inventive |
| N-7 | 210 | 9 | D | Comparative |
| N-8 | 70 | 20 | B | Inventive |
| N-9 | 80 | 21 | A | Inventive |
| P-1 | 80 | 10 | A | Inventive |
| P-2 | 100 | 11 | B | Inventive |
| P-3 | 110 | 8 | B | Inventive |
| P-4 | 90 | 9 | A | Inventive |
| P-5 | 100 | 12 | B | Inventive |
| P-6 | 80 | 10 | A | Inventive |
| P-7 | 100 | 11 | B | Inventive |
| P-8 | 190 | 3 | C | Comparative |
| P-9 | 100 | 12 | B | Inventive |
| P-10 | 90 | 11 | A | Inventive |

As is apparent from Table 3, the inventive planographic printing plate material samples provide excellent sensitivity, printing durability and anti-stain property, as compared with the comparative planographic printing plate material samples.

What is claimed is:

1. A planographic printing plate material comprising a hydrophilic support and provided thereon, an image formation layer whose alkali solubility is changed after near-infrared laser exposure, wherein the image formation layer contains, as an infrared absorbent, a compound having absorption maximum in the wavelength regions of from 700 to 900 nm, the compound being selected from the group consisting of compounds represented by formulae IRD1, IRD2 and IRD3, 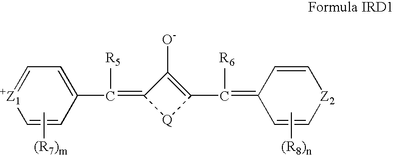
wherein Z₁ and Z₂ independently represent an oxygen atom (O), a sulfur atom (S), a selenium atom (Se) or a tellurium atom (Te); Q represents >C═O or —C(═O)—C(═O)—; R₅ and R₆ independently represent a hydrogen atom or an alkyl group; m and n independently represent an integer of from 0 to 4; and R₇ and R₈ independently represent a substituent, provided that when m is not less than 2, the nearest two R₇'s may combine with each other to form a ring, and when n is not less than 2, the nearest two R₈'s may combine with each other to form a ring, 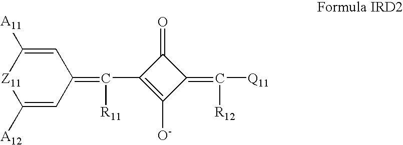
wherein R₁₁ and R₁₂ independently represent a hydrogen atom or a substituent; Z₁₁ represents O, S, N—R₁, Se or Te, in which R₁ represents an alkyl group or an aryl group; Q₁₁ represents a six-member heterocyclic group; and A₁₁ and A₁₂ independently represent a substituent, provided that A₁₁ and A₁₂ are not the same, 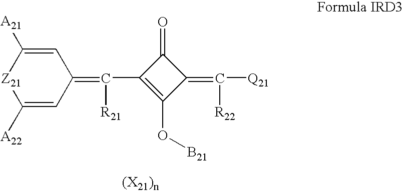
wherein R₂₁ and R₂₂ independently represent a hydrogen atom or a substituent; Z₂₁ represents O, S, N—R₂, Se or Te, in which R₂ represents an alkyl group or an aryl group; Q₂₁ represents a six-member heterocyclic group; and A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, and n is 0 or 1.

2. The planographic printing plate material of claim 1, wherein the compound represented by formula IRD2 and the compound represented by formula IRD3 is a compound represented by formula IRD4, and a compound represented by formula IRD5, respectively, 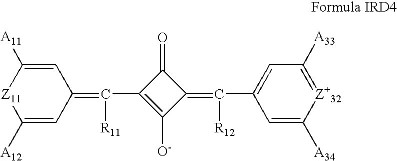
wherein R₁₁ and R₁₂ independently represent a hydrogen atom or a substituent; Z₁₁ represents O, S, N—R₁, Se or Te, in which R₁ represents an alkyl group or an aryl group; A₁₁ and A₁₂ independently represent a substituent, provided that A₁₁ and A₁₂ are not the same; Z₃₂ represents O, S, N—R₃, Se or Te, in which R₃ represents an alkyl group or an aryl group; and A₃₃ and A₃₄ independently represent a hydrogen atom or a substituent, 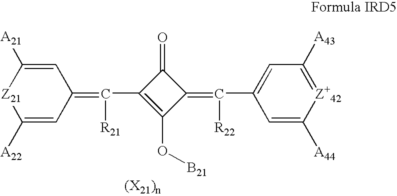
wherein R₂₁ and R₂₂ independently represent a hydrogen atom or a substituent; Z₂₁ represents O, S, N—R₂, Se or Te, in which R₂ represents an alkyl group or an aryl group; A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, n is 0 or 1; Z₄₂ represents O, S, N—R₄, Se or Te, in which R₄ represents an alkyl group or an aryl group; and A₄₃ and A₄₄ independently represent a hydrogen atom or a substituent.

3. The planographic printing plate material of claim 2, wherein the compound represented by formula IRD4 and the compound represented by formula IRD5 is a compound represented by formula IRD6, and a compound represented by formula IRD7, respectively, 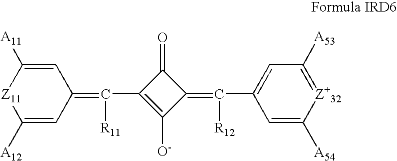
wherein R₁₁ and R₁₂ independently represent a hydrogen atom or a substituent; Z₁₁ represents O, S, N—R₁, Se or Te, in which R₁ represents an alkyl group or an aryl group; A₁₁ and A₁₂ independently represent a substituent, provided that A₁₁ and A₁₂ are not the same; Z₃₂ represents O, S, N—R₃, Se or Te, in which R₃ represents an alkyl group or an aryl group; and A₅₃ and A₅₄ independently represent a substituent, provided that A₅₃ and A₅₄ are not the same, 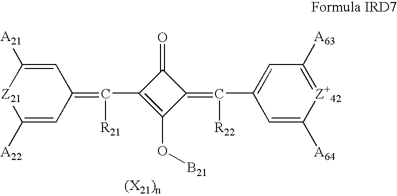
wherein R₂₁ and R₂₂ independently represent a hydrogen atom or a substituent; Z₂₁ represents O, S, N—R₂, Se or Te, in which R₂ represents an alkyl group or an aryl group; A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, and n is 0 or 1; Z₄₂ represents O, S, N—R₄, Se or Te, in which R₄ represents an alkyl group or an aryl group; and A₆₃ and A₆₄ independently represent a substituent, provided that A₆₃ and A₆₄ are not the same.

4. The planographic printing plate material of claim 3, wherein the compound represented by formula IRD6 and the compound represented by formula IRD7 is a compound represented by formula IRD8, and a compound represented by formula IRD9, respectively, 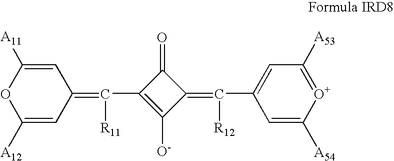
wherein R₁₁ and R₁₂ independently represent a hydrogen atom or a substituent; A₁₁ and A₁₂ independently represent a substituent; and A₅₃ and A₅₄ independently represent a substituent, provided that A₅₃ and A₅₄ are not the same, 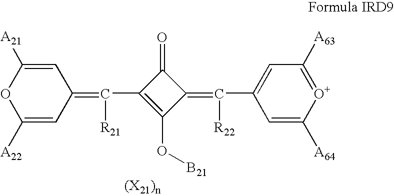
wherein R₂₁ and R₂₂ independently a hydrogen atom or a substituent; A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, n is 0 or 1; and A₆₃ and A₆₄ independently represent a substituent, provided that A₆₃ and A₆₄ are not the same.

5. The planographic printing plate material of claim 4, wherein the compound represented by formula IRD8 is a compound represented by formula IRD10, 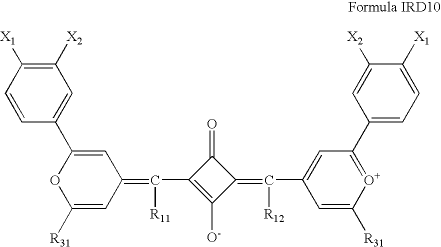
wherein R₁₁ and R₁₂ independently represent a hydrogen atom or a substituent; X₁ and X₂ independently represent a halogen atom; and R₃₁ represents an alkyl group.

6. The planographic printing plate material of claim 1, wherein the hydrophilic support is an aluminum support obtained by a process comprising the steps of electrolytically surface roughening an aluminum plate and anodizing the electrolytically surface roughened aluminum plate, and the image formation layer further contains an alkali soluble binder, a cross-linking agent and an acid generation compound.

7. The planographic printing plate material of claim 6, wherein the alkali soluable binder is novolak resin.

8. The planographic printing plate material of claim 6, wherein the cross-linking agent is a melamine resin.

9. The planographic printing plate material of claim 6, wherein the acid generation compound is a triazine compound.

10. The planographic printing plate material of claim 6, wherein the electrolytically surface roughening is carried out in a hydrochloric acid solution.

11. The planographic printing plate material of claim 1, the hydrophilic support is an aluminum support obtained by a process comprising the steps of electrolytically surface roughening an aluminum plate and anodizing the electrolytically surface roughened aluminum plate, and the image formation layer further contains an alkali soluble binder, an acid decomposable compound and an acid generation compound.

12. The planographic printing plate material of claim 11, wherein the alkali soluble binder is novolak resin.

13. The planographic printing plate material of claim 11, wherein the acid generation compound is a triazine compound.

14. The planographic printing plate material of claim 11, wherein the electrolytically surface roughening is carried out in a hydrochloric acid solution.

15. A process of manufacturing a planographic printing plate material, the process comprising the steps of:
dissolving a composition comprising a compound having absorption maximum in the wavelength regions of from 700 to 900 nm in a ketone solvent to provide a light sensitive coating liquid; and
coating the light sensitive coating liquid on a hydrophilic support, wherein the compound is selected from the group consisting of compounds represented by formulae IRD1, IRD2 and IRD3, 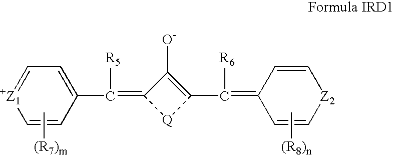
wherein Z₁ and Z₂ independently represent an oxygen atom (O), a sulfur atom (S), a selenium atom (Se) or a tellurium atom (Te); Q represents >C═O or —C(═O)—C(═O)—; R₅ and R₆ independently represent a hydrogen atom or an alkyl group; m and n independently represent an integer of from 0 to 4; and R₇ and R₈ independently represent a substituent, provided that when m is not less than 2, the nearest two R₇'s may combine with each other to form a ring, and when n is not less than 2, the nearest two R₈'s may combine with each other to form a ring. 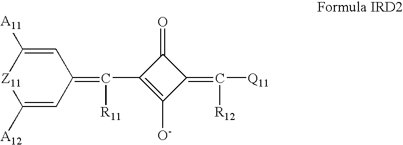
wherein R₁₁ and R₁₂ independently represent a hydrogen atom or a substituent; Z₁₁ represents O, S, N—R₁, Se or Te, in which R₁ represents an alkyl group or an aryl group; Q₁₁ represents a six-member heterocyclic group; and A₁₁ and A₁₂ independently represent a substituent, provided that A₁₁ and A₁₂ are not the same, 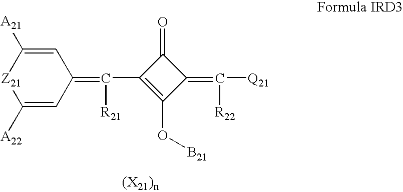
wherein R₂₁ and R₂₂ independently represent a hydrogen atom or a substituent; Z₂₁ represents O, S, N—R₂, Se or Te, in which R₂ represents an alkyl group or an aryl group; Q₂₁ represents a six-member heterocyclic group; and A₂₁ and A₂₂ independently represent a substituent, provided that A₂₁ and A₂₂ are not the same; B₂₁ represents an alkyl group or an aryl group; X₂₁ represents an ion necessary to neutralize the charge of the molecule, and n is 0 or 1.
